(19) United States
(12) Patent Application Publication
(10) Pub. No.: US 2022/0264796 A1
(43) Pub. Date: Aug. 25, 2022

(54) Combine and Threshing Device

(71) Applicant: Kubota Corporation, Osaka-shi (JP)

(72) Inventors: Yoshiaki Inoue, Sakai-shi (JP); Takafumi Mitsui, Sakai-shi (JP); Tsuyoshi Kumatori, Sakai-shi (JP); Toshinari Nishimura, Sakai-shi (JP); Takahiro Ohira, Sakai-shi (JP)

(21) Appl. No.: 17/631,360

(22) PCT Filed: Jul. 30, 2020
(86) PCT No.: PCT/JP2020/029204

§ 371 Date: Jan. 28, 2022

(30) Foreign Application Priority Data
Jul. 31, 2019 (JP) 2019-140471
Jul. 31, 2019 (JP) 2019-140580
Jul. 31, 2019 (JP) 2019-140581

(51) Int. Cl. A01D 41/12

(52) U.S. Cl. CPC A01D 41/1261

(57) ABSTRACT

A combine includes a threshing device and a grain tank that is located above the threshing device and stores threshed grain. A threshing cylinder 31 is located in a threshing chamber and rotates about a front-rear axis, and an arc-shaped receiving net extends along an outer circumferential portion of the threshing cylinder 31. A raking unit 33 is located in a front portion of the threshing cylinder 31 and rakes in reaped culm, and a threshing processing unit 34 is located rearward of the raking unit 33 in the threshing cylinder 31 and threshes the reaped culm. A top plate 30 includes a portion that extends from a location corresponding to an upper portion of the raking unit 33 to a location corresponding to an upper portion of the threshing processing unit 34 and that is removable from a main body portion of the threshing device in a body-rearward direction.

### CROSS-REFERENCE TO RELATED APPLICATIONS

This application is the United States national phase of International Application No. PCT/JP2020/029204 filed Jul. 30, 2020, and claims priority to Japanese Patent Application Nos. 2019-140471, 2019-140580, and 2019-140581, filed Jul. 31, 2019, the disclosures of which are hereby incorporated by reference in their entirety.

### BACKGROUND OF THE INVENTION

### Field of the Invention

The present invention relates to a combine and a threshing device.

### Description of Related Art

In a combine disclosed in JP 2013-183717A (Patent Document 1), a top plate that covers the upper portion of a threshing chamber can be swung open upward around a front-rear axis located on one end side in the lateral direction in order to inspect and clean a threshing device. A grain tank located above the threshing device can be swung open upward around a front-rear axis on one end side in the lateral direction in order to provide greater access to the upper side of the threshing device.

In a combine disclosed in JP 2019-076034A (Patent Document 2), a grain tank for storing grain obtained by threshing is provided at a position above a threshing device.

In the combine having the above configuration, the threshing device has a configuration in which the outer peripheral portion of a threshing unit that performs threshing is surrounded by a highly rigid substantially box-shaped support frame that is provided with, as reinforcing members, substantially plate-shaped side wall portions that are located on the left and right sides of the threshing unit and extend over substantially the entirety thereof in both the up-down direction and the front-rear direction, and this support frame supports the grain tank from below.

A threshing device disclosed in JP 2016-036261A (Patent Document 3) includes a threshing unit and a sorting unit that is arranged below the threshing unit, a harvested crop is threshed by the threshing unit, and the processed material obtained by the threshing unit is sorted by the sorting unit.
Patent Document 1: JP 2013-183717A
Patent Document 2: JP 2019-076034A
Patent Document 3: JP 2016-036261A

### SUMMARY OF THE INVENTION

The following is a problem corresponding to Patent Document 1.

In the above-described configuration in which the top plate is swung upward to open the threshing chamber to the outside, the top plate is swung a large amount upward when performing maintenance work such as inspection and cleaning of the threshing device, and thus a large amount of space is required on the upper side to swing the top plate. For this reason, a mechanism is required to provide wide access to the grain tank, which has a disadvantage of complicating the support structure of the grain tank. Also, in order to swing the top plate, a worker needs to climb to a high place, which also has a disadvantage that work becomes difficult to perform.

In view of this, there is desire for a combine that enables easily performing maintenance work inside the threshing device without leading to complication of the structure.

The following is a problem corresponding to Patent Document 2.

In the above-described conventional configuration, the heavy grain tank can be stably supported by the highly rigid support frame, but the lateral side surfaces of the threshing unit are covered by the substantially plate-shaped side wall portions that serve as frame components.

In order to thresh grain culm, the threshing device includes a rotationally-driven threshing cylinder, an arc-shaped receiving net that is provided along the outer peripheral portion of the threshing cylinder, and the like. As the threshing device operates, maintenance work such as internal cleaning, inspection, and repair is required. It has been necessary to remove the side wall portions in order to perform such maintenance work.

In the above-described conventional configuration, in order for the side wall portions of the threshing device to improve the rigidity as frame components, multiple reinforcing members are added to thick plate bodies, and furthermore, the side wall portions are large members that extend over a wide range in the up-down direction and the front-rear direction. As a result, the task of removing the side wall portions, which are large members, is burdensome and troublesome.

In order to facilitate attachment/detachment so as to eliminate such disadvantages, it is conceivable to give the side wall portions of the threshing device a lighter and simpler structure, provide multiple vertical frame bodies that extend upward from the body frame at locations laterally outward of the side wall portions, and directly support the grain tank with the vertical frame bodies. However, with this improved configuration, there is a disadvantage that the vertical frame bodies become obstacles when performing work such as removing the receiving net inside the threshing device during maintenance work, thus making the work difficult.

In view of this, there is desire for a combine that enables easily performing maintenance work inside the threshing device while also favorably supporting the grain tank.

The following is a problem corresponding to Patent Document 3.

In threshing devices of recent years, improvements in threshing performance in threshing units have made it possible to thresh large amounts of crop. Accordingly, a large amount of processed material is supplied from the threshing unit to the sorting unit, and thus there is desire for a threshing device that has a reinforced structure for reciprocating driving of the sorting unit.

The following is a solution to a problem of Patent Document 1:

A combine according to an aspect of the present invention includes: a threshing device configured to thresh reaped culm in a threshing chamber; a grain tank disposed above the threshing device and configured to store grain threshed by the threshing device; a threshing cylinder disposed in the threshing chamber and configured to rotate about a front-rear axis; an arc-shaped receiving net extending along an outer circumferential portion of the threshing cylinder; a raking unit disposed at a front portion of the threshing cylinder and configured to rake in reaped culm; and a threshing processing unit that is located rearward of the raking unit in the threshing cylinder and is configured to thresh the reaped culm, wherein the threshing device includes a top plate covering an upper portion of the threshing chamber and including a portion that extends from a position corresponding to an upper portion of the raking unit to a position corresponding to an upper portion of the threshing processing unit and that is removable from a body portion of the threshing device rearward relative to a body of the combine.

According to the present invention, when performing maintenance work such as the inspection and cleaning of the inside of the threshing chamber, the top plate that covers the upper portion of the threshing chamber can be attached and detached along the rotation axis direction of the threshing cylinder. According to this configuration, the worker can work from a low position on one lateral side of the body instead of climbing to a high position as in the case of swinging the top plate upward. Also, for example, even if the grain tank is arranged above the threshing device, the grain tank does not need to be provided with a special retracting structure in order to open the top plate, and the support structure can be simple.

Also, in the raking unit of the threshing cylinder, spiral blades or the like are provided on the outer peripheral portion of the threshing cylinder, and reaped culm carried in from the threshing inlet is raked rearward. Since reaped culm is transported as-is in the raking unit, there is a risk that the grain culm may become caught on and remain on the spiral blades and accumulate in lumps, and the inner surface of the top plate may become worn.

Also, in the threshing processing unit of the threshing cylinder, threshing teeth for threshing processing are provided on the outer peripheral portion of the threshing cylinder, and the threshing (grain removal) of reaped culm is performed between the threshing teeth and the receiving net. In this threshing processing unit, the space between the threshing teeth and the top plate is narrow, and the top plate may become worn due to contact with the threshing processing unit.

In view of this, the portion of the top plate that extends from the portion corresponding to the upper portion of the raking unit to the portion corresponding to the upper portion of the threshing processing unit is given a removable configuration. As a result, the outer peripheral side of the threshing cylinder is exposed in both the raking unit and the threshing processing unit, and thus maintenance work such as cleaning and inspection/repair can be performed favorably.

Accordingly, it is possible to easily perform maintenance work inside the threshing chamber without leading to complication of the structure.

In an aspect of the present invention, it is preferable that the top plate includes: at a front end portion thereof, a front wall portion fixed to the body portion of the threshing device; and a flange portion extending rearward relative to the body of the combine from the front wall portion, the top plate includes a movable top plate portion capable of being inserted and pulled out, and the movable top plate portion includes a front end portion closely fitted in an inner surface potion of the flange portion.

According to this configuration, the movable top plate portion can be removed rearward while leaving the front wall portion of the top plate on the main body portion of the threshing device. The front end portion of the movable top plate portion is closely fitted into the inner surface portion of the flange portion of the front wall portion. As a result, when the movable top plate portion is pulled out rearward and then reattached, the front wall portion and the movable top plate portion are in close contact with each other, and the leakage of dust from the threshing chamber to the outside can be avoided.

In an aspect of the present invention, it is preferable that the top plate includes: at a front end portion thereof, a front wall portion fixed to the body portion of the threshing device; and a flange portion extending rearward relative to the body of the combine from the front wall portion, the top plate includes a movable top plate portion capable of being inserted and pulled out, and the movable top plate portion includes a front end portion closely fitted around an outer surface potion of the flange portion.

According to this configuration, the movable top plate portion can be removed rearward while leaving the front wall portion of the top plate on the main body portion of the threshing device. The front end portion of the movable top plate portion is closely fitted around the outer surface portion of the flange portion of the front wall portion. As a result, when the movable top plate portion is pulled out rearward and then reattached, the front wall portion and the movable top plate portion are in close contact with each other, and the leakage of dust from the threshing chamber to the outside can be avoided.

In an aspect of the present invention, it is preferable that the top plate includes a sealing member between the flange portion and the front end portion of the movable top plate portion.

According to this configuration, the sealing member can be used to favorably maintain close contact between the front wall portion and the movable top plate portion, and the leakage of dust from the threshing chamber to the outside can be reliably avoided.

In an aspect of the present invention, it is preferable that the combine further includes a guide member disposed below the raking unit and configured to guide introduced reaped culm, and that the guide member is removable forward relative to the body of the combine.

The body-front side of the raking unit is given a wide opening in order for the introduction of reaped culm into the threshing chamber. In view of this, in this configuration, the guide member provided below the raking unit is removed toward the body-front side. As a result, work can be performed more easily than in the case of a configuration in which the guide member is removed laterally outward from the body, for example.

The following is a solution to a problem of Patent Document 2:

A combine according to an aspect of the present invention includes: a threshing device supported by a body frame and configured to thresh reaped grain; a grain tank disposed above the threshing device and configured to store grain obtained by the threshing; and a support frame that supports the grain tank to the body frame, wherein the threshing device has at least a laterally outward side portion thereof an opening extending from a front portion of the threshing device to a rear portion of the threshing device and capable of being exposed and closed with a lid, the support frame includes: a front support column forward of a front end of the opening; a rear support column rearward of a rear end of the opening; a first lateral coupling body that couples an upper end portion of the front support column to an upper end portion of the rear support column; a second lateral coupling body that couples the front support column to the rear support column between the first lateral coupling body and an upper end of the opening; and a vertical coupling body that couples the first lateral coupling body to the second lateral coupling body, and the support frame does not overlap with the opening in a side view of a body of the combine.

According to the present invention, the grain tank is supported by the body frame via the support frame, and the side wall portion of the threshing device does not need to bear the load of the grain tank. As a result, the side wall portion does not need to be a large and heavy member such as a thick and large area plate member provided with reinforcing members. Also, in the support frame, the front support column and the rear support column are coupled by the first lateral coupling body and the second lateral coupling body, and the first lateral coupling body and the second lateral coupling body are coupled to each other by the vertical coupling body so as to be integrally assembled together.

The first lateral coupling body and the second lateral coupling body are coupled by the front support column and the rear support column on both the front and rear sides, and are coupled by the vertical coupling body in a front-rear intermediate portion, and thus the first rigidity can be higher than in the case where the grain tank is supported by only the first lateral coupling body. As a result, the support frame can be provided with rigidity sufficient for supporting the grain tank.

Also, an opening that extends between the front end and the rear portion is formed in a lateral outer side portion of the threshing device, the front support column is located forward of the front end portion of the opening, the rear support column is located rearward of the rear end of the opening, and the support frame is not overlapped with the opening in a side view of the body. As a result, when performing maintenance work inside the threshing device, it is possible to easily perform work such as removing members inside the threshing device by removing the lid to expose the opening.

Accordingly, in a combine in which the grain tank is provided above the threshing device, it is possible to easily perform maintenance work inside the threshing device while favorably supporting the grain tank.

In an aspect of the present invention, it is preferable that the grain tank protrudes laterally outward of the threshing device on a side, and the first lateral coupling body is laterally outward of the second lateral coupling body on the side, and supports, from below, a protruding portion of the grain tank that protrudes laterally outward on the side.

According to this configuration, the storage amount can be increased by allowing the grain tank to protrude laterally outward to one side. The first lateral coupling body is located on one lateral outer side of the second lateral coupling body that is located near the threshing device, and the protruding portion of the grain tank is supported by the first lateral coupling body, thus making it possible to stably support the grain tank over a wide range in the lateral direction.

In an aspect of the present invention, it is preferable that the threshing device includes: a threshing cylinder; and an arc-shaped receiving net extending along an outer peripheral portion of the threshing cylinder, the second lateral coupling body is laterally outward of the threshing cylinder on a side and faces the threshing cylinder, the second lateral coupling body has a laterally inward side surface that faces the threshing cylinder, the laterally inward side surface being a flat surface smooth in an up-down direction, the second lateral coupling body includes an upper portion wider than a lower portion of the second lateral coupling body, the receiving net is continuous in a circumferential direction with the laterally inward side surface of the second lateral coupling body, and the second lateral coupling body includes a narrow lower portion provided with a coupling bracket coupled to a laterally outward side thereof.

According to this configuration, when the threshing cylinder rotates to thresh reaped culm, the smooth side surfaces on the laterally inward sides of the second lateral coupling body guide the reaped culm smoothly so as to not become caught or accumulate, and the reaped culm can be transferred to the receiving net, and threshing can be performed favorably.

The lateral outer side of the lower portion of the second lateral coupling body extends laterally inward more the upper portion. A bracket for coupling the receiving net is coupled to this extending portion. As a result, when the lid is attached to the laterally outward side in the upper portion of the second lateral coupling body, the bracket for coupling the receiving net does not get in the way, and the lid can be attached favorably.

In an aspect of the present invention, it is preferable that the threshing device includes a top plate covering an upper portion of the threshing chamber, the second lateral coupling body protrudes laterally outward of an outer end portion of the top plate on one lateral side, and the second lateral coupling body includes at an upper portion thereof; a top plate placement section on which the top plate is placeable and supportable; and a coupling body support section that supports the vertical coupling body at a position laterally outward of the top plate placement section.

According to this configuration, the top plate is placed on and supported by the upper portion of the second lateral coupling body, and the vertical coupling body is also supported by the upper portion of the second lateral coupling body, and thus such dual usage of the same member allows a simpler configuration than in the case of separately providing a frame body for supporting the top plate and a frame body for supporting the vertical coupling body.

In an aspect of the present invention, it is preferable that the grain tank includes a bottom portion provided with a bottom screw that extends laterally and that is configured to transport grain from the grain tank laterally outward to a side, and the vertical coupling body is below the bottom screw in a side view.

According to this configuration, the bottom screw of the grain tank is often provided near the center position in the width direction in order to efficiently discharge the grain. As a result, the region located below the bottom screw is close to the position of the center of gravity of the grain tank, and is a region where the load on the second lateral coupling body is large. By providing the vertical coupling body in this region where the load is large, the load on the second lateral coupling body can be reduced, and the rigidity of the entire support frame can be accordingly increased.

In an aspect of the present invention, it is preferable that the combine further includes an engine above the threshing device and rearward of the grain tank, and that the vertical coupling body is below an output shaft of the engine in a side view.

According to this configuration, the output shaft of the engine is often provided near the center position of the engine. As a result, the region below the output shaft is close to the position of the center of gravity of the engine, and is a region where the load on the second lateral coupling body is large. By providing the vertical coupling body in this region where the load is large, the load on the second lateral coupling body can be reduced, and the rigidity of the entire support frame can be accordingly increased.

The following is a solution to a problem with Patent Document 3:

A threshing device according to an aspect of the present invention includes: a threshing unit configured to thresh a harvested crop; a sorting unit disposed below the threshing unit, supported in such a manner as to be reciprocally drivable in a front-rear direction, and configured to sort a processed material from the threshing unit; a drive unit configured to output motive power for reciprocating; and a drive member connected to the sorting unit and drivable on the motive power from the drive unit to reciprocally swing around an axis extending along a left-right direction, and drive the sorting unit to reciprocate, wherein the drive member includes: a first member supported in such a manner as to be swingable around the axis and connected to the drive unit; a second member supported in such a manner as to be swingable around the axis and connected to the sorting unit; and a third member that is connected to a first connection portion at which the drive unit and the first member are connected to each other and a second connection portion at which the sorting unit and the second member are connected to each other and that extends between the first connection portion and the second connection portion.

According to the present invention, a drive member is provided for driving the sorting unit to reciprocate in the front-rear direction, and the drive member is supported so as to be swingable around an axis that extends along the left-right direction. The drive member is not shaped as a single rod, but rather has a first member, a second member, and a third member.

According to the present invention, motive power from the drive unit is transmitted to the first member and the third member of the drive member, and is transmitted to the sorting unit via the second member of the drive member, via the third member of the drive member, or via the second member and the third member of the drive member, and thus the sorting unit is driven to reciprocate.

In this case, the drive member includes the third member that is connected to and extends between the connection portion between the drive unit and the first member and the connection portion between the sorting unit and the second member, and thus the drive member has sufficient strength along the swing direction.

Accordingly, when the sorting unit is driven to reciprocate by the drive member while a large amount of processed material has been supplied from the threshing unit to the sorting unit, the sorting unit is driven to reciprocate by the drive member that has sufficient strength, thus making it possible to strengthen the structure for reciprocating driving of the sorting unit.

In an aspect of the present invention, it is preferable that the third member is in a shape of a plate with a dimension in a swing direction that is larger than a dimension thereof in a direction orthogonal to the swing direction.

When the drive member is driven to reciprocally swing, it is conceivable that the third member of the drive member is subjected to a bending load acting along the swing direction.

According to the present invention, the third member of the drive member is plate-shaped with a larger width in the swing direction than in the direction orthogonal to the swing direction, and the third member of the drive member has a large second moment of area.

Accordingly, the third member of the drive member is plate-shaped, which is advantageous in terms of making the drive member compact overall, and furthermore the third member of the drive member has sufficient strength with respect to a bending load that acts along the swing direction.

In an aspect of the present invention, it is preferable that the first member and the second member are each in a shape of a plate with a dimension in a swing direction that is larger than a dimension thereof in a direction orthogonal to the swing direction.

When the drive member is driven to reciprocally swing, it is conceivable that the first member and the second member of the drive member are subjected to a bending load acting along the swing direction.

According to the present invention, the first member and the second member of the drive member are plate-shaped with a larger width in the swing direction than in the direction orthogonal to the swing direction, and the first member and the second member of the drive member have a large second moment of area.

Accordingly, the first member and the second member of the drive member are plate-shaped, which is advantageous in terms of making the drive member compact overall, and furthermore the first member and the second member of the drive member have sufficient strength with respect to a bending load that acts along the swing direction.

In an aspect of the present invention, it is preferable that the third member is triangular in a side view, and includes: a portion supported in such a manner as to be swingable around the axis and extending along the first member; a portion supported in such a manner as to be swingable around the axis and extending along the second member; and a portion extending between the first connection portion and the second connection portion.

According to the present invention, the third member, which is connected to and extends between the connection portion between the drive unit and the first member and the connection portion between the sorting unit and the second member, has a triangular shape in a side view and includes a portion that is supported to be swingable around the axis and extends along the first member, and a portion that is supported to be swingable around the axis and extends along the second member.

As a result, the drive member is provided with the first member and the portion of the third member that extends along the first member, both of which extend between the drive unit and the axis, and is provided with the second member and the portion of the third member that extends along the second member, both of which extend between the sorting unit and the axis, and thus the strength of the drive member is improved.

In an aspect of the present invention, it is preferable that the first member and the second member are separated by a gap in a direction along the axis, and the third member is between the first member and the second member in a front view.

In the case where motive power from the drive unit is transmitted to the first member and the third member of the drive member, and is transmitted to the sorting unit via the second member of the drive member, via the third member of the drive member, or via the second member and the third member of the drive member, according to the present invention, the third member of the drive member is arranged between the first member and the second member, and thus motive power from the drive unit is transmitted to the sorting unit in a balanced manner without bias.

In an aspect of the present invention, it is preferable that the first member and the second member are coupled to a single boss portion supported in such a manner as to be rotatable around the axis, so that the first member and the second member are each supported in such a manner as to be swingable around the axis.

According to the present invention, the first member and the second member of the drive member are supported via the same boss portion so as to be swingable around the axis, thus easily obtaining a configuration in which the first member and the second member of the drive member described above are arranged with a gap therebetween along the axis, which is advantageous in terms of simplifying the structure for supporting the first member and the second member of the drive member.

In an aspect of the present invention, it is preferable that the third member is triangular in a side view, and includes: a portion extending along the first member, a portion extending along the second member, and a portion extending between the first connection portion and the second connection portion, and the portion extending along the first member and the portion extending along the second member are coupled to the boss portion.

According to the present invention, the third member, which is connected to and extends between the connection portion between the drive unit and the first member and the connection portion between the sorting unit and the second member, has a triangular shape in a side view and includes a portion that is supported to be swingable around the axis and extends along the first member, and a portion that is supported to be swingable around the axis and extends along the second member.

As a result, the drive member is provided with the first member and the portion of the third member that extends along the first member, both of which extend between the drive unit and the axis, and is provided with the second member and the portion of the third member that extends along the second member, both of which extend between the sorting unit and the axis, and thus the strength of the drive member is improved.

According to the present invention, the portion of the third member that extends along the first member in the drive member is coupled to the boss portion to which the first member and the second member of the drive member are coupled, and the portion of the third member that extends along the second member in the drive member is also coupled to the same boss portion, thus easily obtaining a configuration in which the third member of the drive member is arranged between the first member and the second member, which is advantageous in terms of simplifying the structure for supporting the first member, the second member, and the third member of the drive member.

In an aspect of the present invention, it is preferable that the threshing device further includes: a first connecting portion disposed between the first member and the third member in a front view and coupled to the first member and the third member; and a second connecting portion disposed between the second member and the third member in a front view and coupled to the second member and the third member, and that the drive unit and the first connecting portion are connected to each other, and the sorting unit and the second connecting portion are connected to each other.

According to the present invention, in the connection portion where the drive unit is connected to the first member and the third member of the drive member, the first connecting portion is arranged between the first member and the third member of the drive member, and is coupled to the first member and the third member, and the drive unit and the first connecting portion are connected to each other.

Accordingly, the first connecting portion has sufficient strength and is coupled to the first member and the third member of the drive member, and motive power from the drive unit is easily transmitted from the first connecting portion to the first member and the third member of the drive member.

According to the present invention, in the connection portion where the sorting unit is connected to the second member and the third member of the drive member, the second connecting portion is arranged between the second member and the third member of the drive member, and is coupled to the second member and the third member, and the sorting unit and the second connecting portion are connected to each other.

Accordingly, the second connecting portion has sufficient strength and is coupled to the second member and the third member of the drive member, and motive power from the drive unit is easily transmitted from the second member and the third member of the drive member to the sorting unit via the second connecting portion.

Other feature configurations and advantages achieved thereby will become apparent in the following description.

### BRIEF DESCRIPTION OF THE DRAWINGS

FIG. 1 is a diagram showing a first embodiment (hereinafter, the same applies up to FIG. 16), and is an overall side view of a combine.

FIG. 2 is an overall plan view of the combine.

FIG. 3 is a vertical sectional side view of a threshing device.

FIG. 4 is a side view showing a frame structure.

FIG. 5 is a side view of a left wall portion when a lid has been removed.

FIG. 6 is a side view of a right wall portion.

FIG. 7 is a perspective view showing a frame structure.

FIG. 8 is a vertical sectional front view of the threshing device.

FIG. 9 is a plan view showing the sliding of a top plate.

FIG. 10 is a vertical sectional side view of a front wall portion of the top plate.

FIG. 11 is a front view of a threshing inlet plate arrangement portion.

FIG. 12 is a cross-sectional view showing a coupled state of a threshing inlet plate.

FIG. 13 is a plan view of the top plate according to another embodiment.

FIG. 14 is a vertical sectional front view of the top plate according to the other embodiment.

FIG. 15 is a cross-sectional view of a bolting portion before coupling.

FIG. 16 is a cross-sectional view of the bolting portion after coupling.

FIG. 17 is a diagram showing a second embodiment (hereinafter, the same applies up to FIG. 38), and is a left side view of a combine.

FIG. 18 is a left side view of a threshing device.

FIG. 19 is a right side view of the threshing device.

FIG. 20 is a vertical sectional left side view of the threshing device.

FIG. 21 is a vertical sectional left side view of a region including a grain fan.

FIG. 22 is a vertical sectional left side view of a region including a tailings collection unit.

FIG. 23 is a vertical sectional rear view of a region including first, third, and sixth wind direction members.

FIG. 24 is a left side view showing a structure for changing gaps of chaff lips in a first chaff sieve.

FIG. 25 is a vertical sectional front view showing the structure for changing the gaps of chaff lips in the first chaff sieve.

FIG. 26 is a vertical sectional left side view of a region including a rear wall portion of a rear end portion of a second sieve case and a region including a connection portion between a drive arm and a second sorting unit.

FIG. 27 is an exploded perspective view of a guide member and the rear wall portion of the rear end portion of the second sieve case.

FIG. 28 is a perspective view of a region including a grain fan case as viewed from below.

FIG. 29 is a left side view of a region including the grain fan.

FIG. 30 is a left side view showing a rotation speed changing portion of the grain fan.

FIG. 31 is a diagram showing a transmission system for transmitting power from an engine to a threshing cylinder, a first sorting unit, and a second sorting unit.

FIG. 32 is a left side view showing a transmission chain and a tension wheel body that transmit motive power from the engine to the first sorting unit and the second sorting unit.

FIG. 33 is a rear view showing a structure that drives the first sorting unit and the second sorting unit to reciprocate along the front-rear direction.

FIG. 34 is a left side view showing the structure that drives the first sorting unit and the second sorting unit to reciprocate along the front-rear direction.

FIG. 35 is an exploded perspective view of a drive member.

FIG. 36 is a vertical sectional left side view of the drive arm.

FIG. 37 is a left side view showing reciprocating driving of the first sorting unit and the second sorting unit.

FIG. 38 is a left side view showing reciprocating driving of the first sorting unit and the second sorting unit.

### DESCRIPTION OF THE INVENTION

### First Embodiment

The following describes a first embodiment.

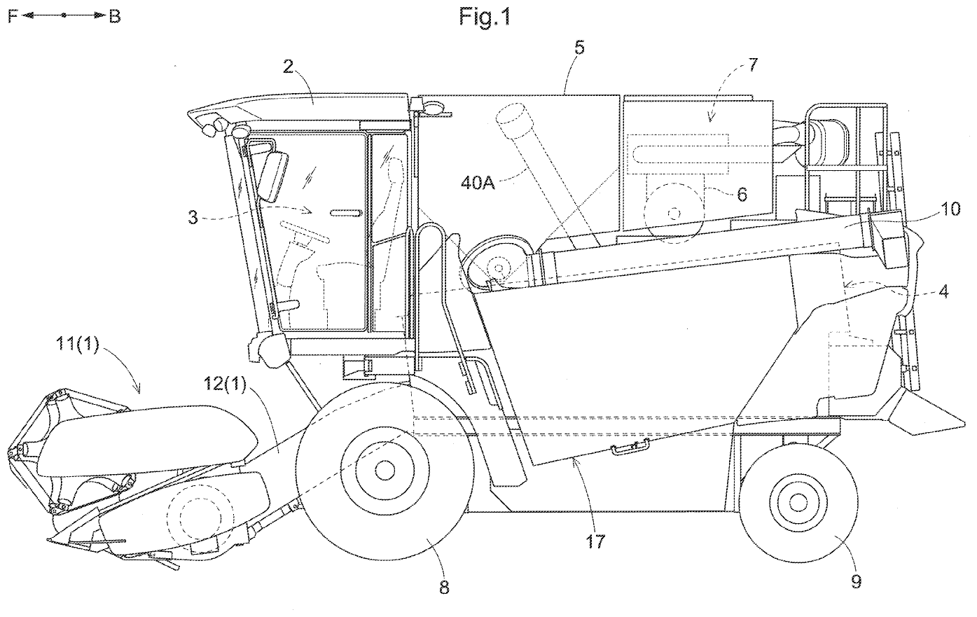

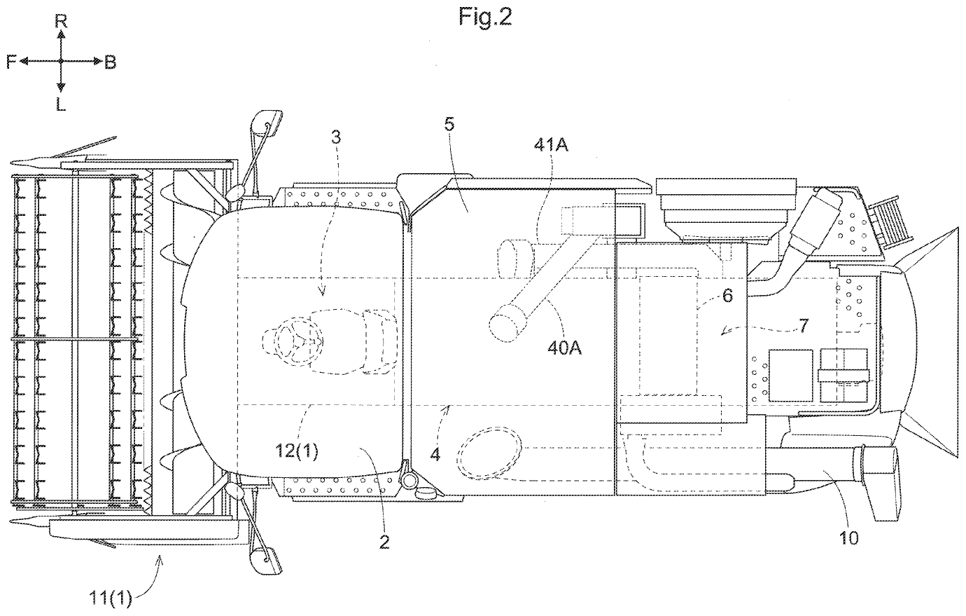

In the following description, the direction of an arrow F is the “front side of the body” (see FIGS. 1 and 2), the direction of an arrow B is the “rear side of the body” (see FIGS. 1 and 2), the direction of an arrow L is the “left side of the body” (see FIG. 2), and the direction of an arrow R is the “right side of the body” (see FIG. 2).

Overall Configuration of Combine

FIGS. 1 and 2 show a normal-type combine, which is one example of a combine. This combine includes, for example, a reaping and transporting unit 1 that reaps and transports planted culm rearward, a driver portion 3 covered by a cabin 2, a threshing device 4 that threshes grain reaped by the reaping and transporting unit 1, a grain tank 5 that stores grain that was threshed by the threshing device 4, a motor unit 7 that includes an engine 6 as a motive power source, a pair of non-steerable left and right front wheels 8 that are rotationally driven, and a pair of steerable left and right rear wheels 9.

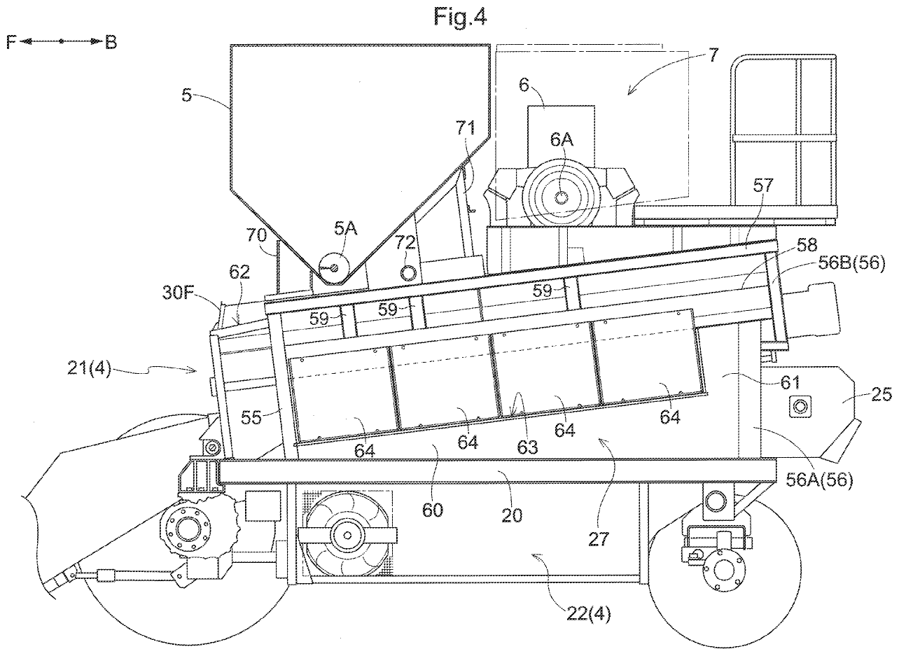

As shown in FIG. 2, the grain tank 5 is wider than the threshing device 4 in a plan view, and the grain tank 5 protrudes laterally outward from the lateral end portions of the threshing device 4 on both sides in the left-right direction. Also, as shown in FIGS. 1 and 4, the bottom surface of the grain tank 5 has a downward tapered shape in a side view, and the grain tank 5 includes a bottom screw 5A by which the grain stored at the lowest point inside the tank is transported outward to the left. The grain tank 5 includes, on the left side, a screw conveyor type grain discharging device 10 by which grain transported by the bottom screw 5A is transported to the outside of the body.

The reaping and transporting unit 1 is provided in a front portion of the body and includes a reaping unit 11 that reaps standing planted culm and gathers the reaped culm toward the center in the reaping width direction, and a feeder 12 that serves as a transporting unit by which the culm that was reaped and gathered toward the center is transported toward the threshing device 4 at the rear of the body.

The rear end portion of the feeder 12 is supported by the body so as to be capable of swinging up and down around a horizontal axis. The entirety of the reaping and transporting unit 1, which includes the feeder 12 and the reaping unit 11, can swing up and down by a hydraulic cylinder for reaping raising and lowering (not shown).

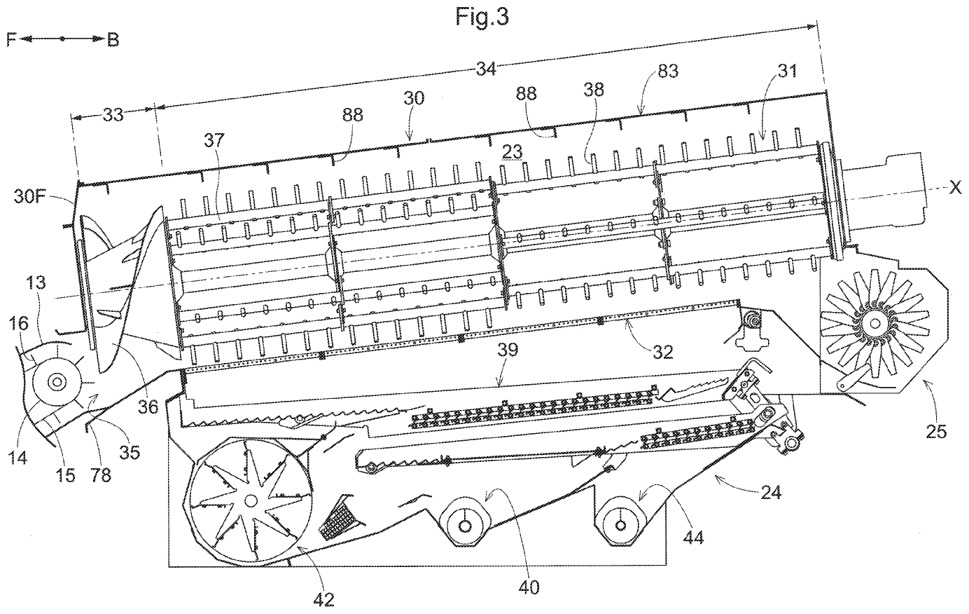

As shown in FIG. 3, in the feeder 12, a plurality of endless rotating chains 15 are wound around front wheel bodies (not shown) and rear wheel bodies 14 in a cylindrical transport case 13, lateral locking carriers 16 are provided across the endless rotating chains 15, and the crop received from the reaping unit 11 is transported rearward and upward.

The threshing device 4 is located at a low position in the central portion in the body left-right direction, and includes, at positions above the threshing device 4, the grain tank 5 for storing grain that was threshed by the threshing device 4, and the engine 6 as a motive power source. The grain tank 5 and the engine 6 are arranged side-by-side in the front-rear direction, with the grain tank 5 being located closer to the body-front side, and the engine 6 being located closer to the body-rear side. The left and right outer sides of the threshing device 4 are covered by exterior covers 17.

As shown in FIGS. 1 and 4 to 8, a pair of left and right main frames 20 that extend in the body front-rear direction are provided in a lower portion of the body. The left and right main frames 20 support the body overall, and the main frames 20 correspond to the body frame.

The left and right main frames 20 have a substantially sideways U-shaped cross-section, and extend a long distance in the front-rear direction from the front portion of the body to the rear portion of the body. An axle for the left and right front wheels 8 and an axle for the left and right rear wheels 9 are provided at positions below the left and right main frames 20. The left and right main frames 20 are supported by the left and right front wheels 8 and the left and right rear wheels 9.

Threshing Device

Next, the threshing device 4 will be described.

As shown in FIGS. 3 and 4, the threshing device 4 includes a threshing unit 21 for performing threshing processing and a sorting unit 22 for sorting the processed material obtained by the threshing processing performed by the threshing unit 21. A threshing chamber 23 for threshing the reaped culm is formed inside the threshing unit 21. The sorting unit 22 includes a sorting processing unit 24 for sorting the threshed processed material into tailings (e.g., grain or grain with branches) and straw waste or the like. A shredding processing device 25 for shredding waste straw obtained by the threshing processing performed by the threshing device 4 is provided rearward of the threshing device 4.

As shown in FIGS. 4 to 8, the threshing unit 21 is placed on and supported by the left and right main frames 20. The threshing unit 21 is surrounded by left and right plate-shaped side wall portions 26 and 27 that extend in the up-down direction, a substantially plate-shaped rear wall portion 28 that connects the rear end portions of the left and right side wall portions 26 and 27, a substantially plate-shaped front wall portion 29 that connects the front end portions of the side wall portions 26 and 27, and a top plate 30 that extends between the left and right side wall portions 26 and 27 and covers them from above, for example. The front wall portion 29 and the rear wall portion 28 include openings for passage of the threshed processed material.

The threshing unit 21 is configured such that the body-front side is narrower in the up-down direction and the body-rear side is wider in the up-down direction. The lower end portion of the threshing unit 21 is placed on the main frames 20 that extend in a substantially horizontal orientation along the front-rear direction. Accordingly, the threshing unit 21 is in a rearward and upward tilted orientation in which the upper end portion rises toward the rear.

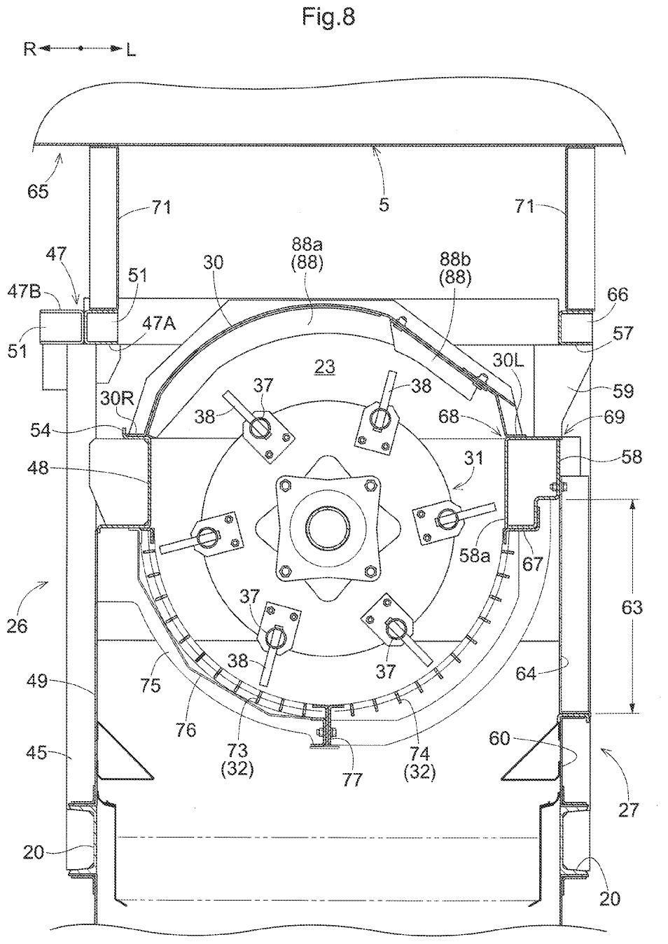

As shown in FIGS. 3 and 8, the threshing chamber 23 is surrounded by the side wall portions 26 and 27 on the left and right sides and the top plate 30 on the upper side. The threshing chamber 23 includes a threshing cylinder 31 that rotates around an axis X along the body front-rear direction, and a receiving net 32 that is located below the threshing cylinder 31 and is substantially arc-shaped in a front view so as to extend along the outer peripheral portion of the threshing cylinder 31.

As shown in FIG. 3, the threshing cylinder 31 includes a raking unit 33 that is positioned toward the front of the body and rakes reaped culm rearward, and a threshing processing unit 34 that is positioned on the body-rear side of the raking unit 33 and threshes the reaped culm. The raking unit 33 is configured to rake reaped culm, which has been fed from the feeder 12 through an inlet 35 of the threshing chamber 23, into the threshing chamber 23 with use of spiral blades 36. The threshing processing unit 34 includes a plurality of rod-shaped members 37 that extend along the rotation axis direction at intervals in the circumferential direction, and a plurality of rod-shaped threshing teeth 38 that project radially outward from each rod-shaped member 37. A threshing inlet plate 78 is provided below the raking unit 33 as a guide member for receiving and guiding the reaped culm. The threshing inlet plate 78 will be described later.

Reaped culm is introduced from the feeder 12 into the threshing chamber 23 and subjected to threshing processing (grain removal processing) by the threshing cylinder 31 and the receiving net 32. The threshing cylinder 31 is arranged in a rearward and upward tilted orientation in which the rotation axis X gradually rises while extending toward the rear of the body. Similarly to the threshing cylinder 31, the receiving net 32 is also arranged in a rearward and upward tilted orientation in a side view.

As shown in FIG. 3, the sorting processing unit 24 includes a swing sorting device 39 that sorts threshed processed material that has dropped from the threshing chamber 23 into tailings (e.g., grain or grain with branches) and straw waste while swinging so as to move the threshed processed material rearward, a clean grain collecting unit 40 for collecting grain, a tailings collecting unit 41 for collecting the tailings, a grain fan 42 for supplying sorting wind to the swing sorting device 39, and the like.

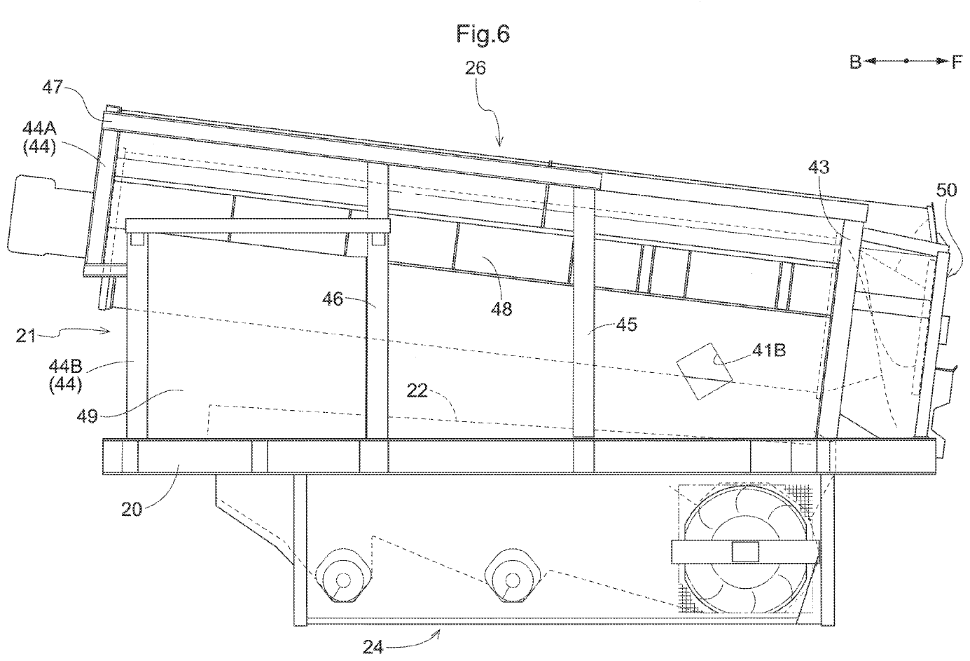

As shown in FIG. 2, the grain collected by the clean grain collecting unit 40 is transported to the inside of the grain tank 5 by a grain lifting device 40A provided outward of the right wall portion 26. The tailings collected by the tailings collecting unit 41 is returned to the inside of the threshing chamber 23 through an opening 41B (see FIG. 6) formed in the right wall portion 26, by a tailings returning device 41A that is provided outward of the right wall portion 26.

Frame Structure

As shown in FIGS. 6 and 8, the right wall portion 26, which is located on the right side out of the left and right side wall portions 26 and 27, has a wall surface for full coverage, with the body-front side being narrower in the up-down direction and the body-rear side being wider in the up-down direction. The lower end portion of the right wall portion 26 is placed on the upper surface of the main frame 20 and bolted to the main frame 20.

The right wall portion 26 will be described below.

The right wall portion 26 includes: a front support column 43 located in the front portion; a rear support column 44 located in the rear portion; two intermediate support columns 45 and 46 arranged with a gap therebetween in a central portion in the front-rear direction; an upper coupling body 47 that extends in the front-rear direction and is coupled to the upper ends of the front support column 43, the rear support column 44, and the two intermediate support columns 45 and 46; an intermediate coupling body 48 that is provided below the upper coupling body 47, is located laterally inward of the support columns 43 to 46, and connects the support columns 43 to 46; and a wall face portion 49 that is plate-shaped and covers a range from the intermediate coupling body 48 to the main frame 20 and is integrally coupled to the support columns 43 to 46, the intermediate coupling body 48, and the main frame 20. Also, the front end portion of the right wall portion 26 is provided with a front support portion 50 that is located outward of the raking unit 33. The rear support column 44 has an upper support column portion 44A and a lower support column portion 44B, which are integrally connected to each other.

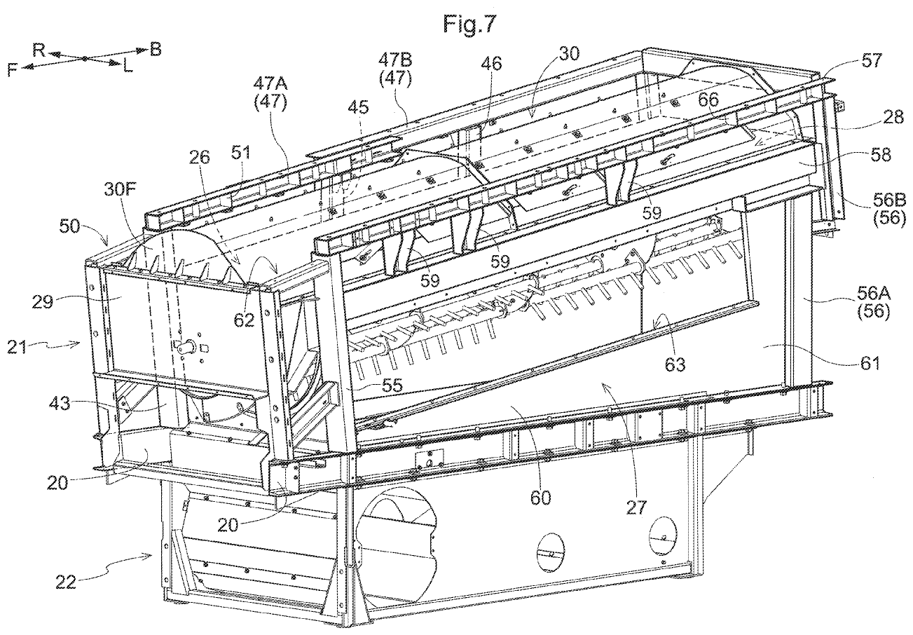

As shown in FIGS. 7 and 8, the upper coupling body 47 has a substantially sideways U-shaped cross-sectional shape, and extends over the entire range from the front support column 43 to the rear support column 44 in the front-rear direction. The upper coupling body 47 includes a front coupling body portion 47A and a rear coupling body portion 47B that are coupled together and continuous in one series. Also, reinforcing ribs 51 are provided at appropriate intervals in the U-shaped inner groove portion.

As shown in FIGS. 6 and 8, the intermediate coupling body 48 has a substantially sideways U-shaped cross-sectional shape that is wide in the up-down direction, and extends over the entire range from the front support column 43 to the rear support column 44 in the front-rear direction. Reinforcing ribs 52 are provided at appropriate intervals in the U-shaped inner groove portion.

The right outer end portion of the top plate 30 is supported on the upper surface of the intermediate coupling body 48. A horizontally-oriented flange portion 30R is provided at the left outer end portion of the top plate 30 and is placed on and supported by the upper surface of the intermediate coupling body 48. The flange portion 30R of the top plate 30 is bolted to the upper surface at a plurality of locations at appropriate intervals in the front-rear direction. A limiting portion 54, which is bent upward in an L shape, is formed on the upper surface of the intermediate coupling body 48, at the end portion thereof that is rightward of the location where the flange portion 30R of the top plate 30 is placed. As will be described later, this limiting portion 54 has a guide function for limiting the position of the top plate 30 in the left-right direction when the top plate 30 is slid in the front-rear direction.

The left wall portion 27 will be described below.

As shown in FIGS. 4, 5, 7, and 8, the left wall portion 27 located on the left side is shaped such that the body-front side is narrower in the up-down direction and the body-rear side becomes gradually wider in the up-down direction. The left wall portion 27 includes a front support column 55 that is located in a front portion, a rear support column 56 that is located in a rear portion, a first lateral coupling body 57 that connects an upper end portion of the front support column 55 to an upper end portion of the rear support column 56, a second lateral coupling body 58 that connects the front support column 55 to the rear support column 56 at a position lower than the first lateral coupling body 57, and a plurality of (three) vertical coupling bodies 59 that connect the first lateral coupling body 57 to the second lateral coupling body 58. The left wall portion 27 also includes a lower plate-shaped portion 60 that is located below the second lateral coupling body 58 and has a substantially triangular shape in a side view so as to increase in width in the up-down direction toward the body-rear side, and a rear plate-shaped portion 61 that is located on the body-rear side and increases in width in the up-down direction. The front end portion of the left wall portion 27 includes a front support portion 62 that is located outward of the raking unit 33. The rear support column 56 includes a lower support column portion 56A that extends in the up-down direction at a rear end portion of the rear plate-shaped portion 61, and an upper support column portion 56B that connects rear ends of the first lateral coupling body 57 and the second lateral coupling body 58, and the like, which are integrally coupled to form a support column on the rear side.

The left wall portion 27 includes a wide opening 63 formed at a location surrounded by the second lateral coupling body 58, the lower plate-shaped portion 60, and the rear plate-shaped portion 61. The opening 63 is closed by four lids 64. Each of the lids 64 is detachably supported along the left-right direction of the body. Specifically, as shown in FIG. 8, the lower end portion of each of the lids 64 is placed on a horizontal surface portion of an upper end portion of the lower plate-shaped portion 60 and bolted thereto, and the upper end portion is bolted to a side surface of the second lateral coupling body 58. The lid 64 can be detached outward to the left (to the right in FIG. 8) by unscrewing the bolts.

As also shown in FIG. 7, in the left wall portion 27, the front support column 55, the rear support column 56, the first lateral coupling body 57, the second lateral coupling body 58, the three vertical coupling bodies 59, the lower plate-shaped portion 60, and the rear plate-shaped portion 61 are integrally coupled to form a frame structure that has high rigidity overall. The left wall portion 27 is provided so as not to be overlapped with the opening 63 in a side view of the body. Accordingly, the left wall portion 27 corresponds to a support frame that supports the grain tank 5.

As shown in FIG. 8, the first lateral coupling body 57 is located outward to the left (an example of one horizontal side) of the second lateral coupling body 58, and supports, from below, a protruding portion 65 that protrudes outward to the left of the grain tank 5. The first lateral coupling body 57 has a substantially sideways U-shaped cross-sectional shape, and extends over the entire range from the front support column 55 to the rear support column 56 in the front-rear direction. Also, reinforcing ribs 66 are provided at appropriate intervals in the U-shaped inner groove portion.

As shown in FIG. 8, the second lateral coupling body 58 is located outward to the left of the threshing cylinder 31 and faces the threshing cylinder 31. A side surface 58a of the second lateral coupling body 58 on the laterally inward side facing the threshing cylinder 31 is a flat surface that is smooth along the up-down direction. An upper portion of the second lateral coupling body 58 has a wider lateral width than a lower portion of the same.

More specifically, the second lateral coupling body 58 has a hollow cylindrical shape, with an upper portion that is wider in the lateral direction and a lower portion that is narrower in the lateral direction. The laterally inward side surface 58a that faces the threshing cylinder 31 is formed by a vertical flat surface that is flat from the upper end to the lower end. On the other hand, the laterally outer side surface on the side opposite to the threshing cylinder 31 has a staircase shape in which the upper portion side is located on the outer side and the lower portion side is located on the inner side.

The receiving net 32 is continuous along the downward circumferential portion of the laterally inward side surface 58a of the second lateral coupling body 58, and a coupling bracket 67 is bolted to the laterally outward side of the narrow lower portion of the second lateral coupling body 58.

The second lateral coupling body 58 projects laterally outward from a left outer end portion of the top plate 30, and an upper portion of the second lateral coupling body 58 includes a top plate placement portion 68 on which the top plate 30 is placed and a coupling body support portion 69 that supports the vertical coupling bodies 59 at a position laterally outward of the top plate placement portion 68.

More specifically, the upper surface 58b of the second lateral coupling body 58 is formed by a horizontal surface that is flat from the right end to the left end. A horizontal flange portion 30L provided at the left outer end portion of the top plate 30 is placed on and supported by the top plate placement portion 68. The flange portion 30L of the top plate 30 is bolted to the top plate placement portion 68 at a plurality of locations at appropriate intervals.

At the upper surface 58b of the second lateral coupling body 58, lower end portions of the vertical coupling bodies 59 are integrally coupled to the coupling body support portion 69. As will be described later, the vertical coupling bodies 59 have a guide function for limiting the shifting of the position of the top plate 30 in the left-right direction when the top plate 30 is slid in the front-rear direction.

As shown in FIG. 7, the vertical coupling bodies 59 are each substantially U-shaped in a plan view, an upper end portion thereof is integrally coupled to the first lateral coupling body 57, and a lower end portion thereof is integrally coupled to the second lateral coupling body 58.

As shown in FIG. 4, in the grain tank 5, the downward-taped bottom surface has a downward and forward inclined bottom surface on the front portion side that is placed on and supported by an upper portion of the left wall portion 27 and an upper portion of the right wall portion 26 via front support bodies 70. An upward and rearward inclined bottom surface on the rear portion side is placed on and supported by an upper portion of the left wall portion 27 and an upper portion of the right wall portion 26 via rear support bodies 71. As shown in FIG. 8, two rear support bodies 71 are respectively provided on the left and right sides, and the right rear support body 71 is supported by and bolted to an upper portion of the right wall portion 26, that is to say the upper coupling body 47. The left rear support body 71 is supported by and bolted to an upper portion of the left wall portion 27, that is to say the first lateral coupling body 57.

As shown in FIG. 4, the vertical coupling body 59 that is located frontmost out of the three vertical connecting bodies 59 is located below the bottom screw 5A of the grain tank 5 in a side view. Also, the vertical coupling body 59 that is located rearmost out of the three vertical coupling bodies 59 is located below the output shaft 6a of the engine 6. The vertical coupling body 59 that is located in the middle in the front-rear direction is located below a tubular member 72 through which a counter shaft (not shown) for power transmission is inserted.

Receiving Net

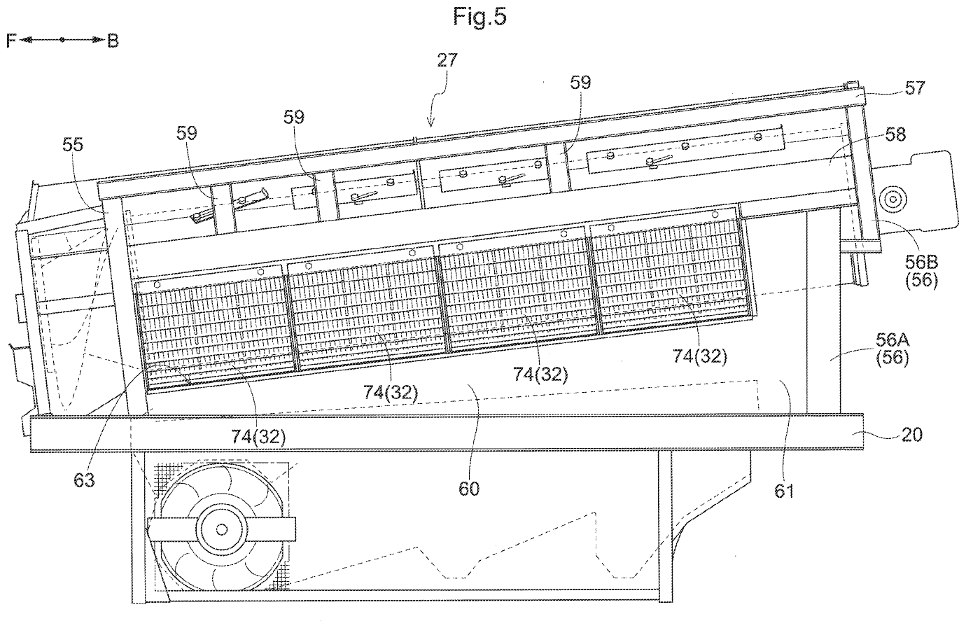

As shown in FIG. 5, the receiving net 32 is divided into four along the rotation axis direction of the threshing cylinder 31, and the divided receiving net portions are detachably supported along the lateral direction. The receiving net 32 is divided at the same position as the lid 64 on the left wall portion 27 along the rotation axis direction of the threshing cylinder 31, and can be detached in the same direction, that is to say toward the body-left side (right side in FIG. 8).

The receiving net 32 is constituted by two receiving net components 73 and 74 that are divided along the circumferential direction of the threshing cylinder 31. The right receiving net component 73 is stopped and guided by an arc-shaped guide member 76 attached to the front and rear surfaces of a partition member 75, and is supported in a state where the right end portion is in contact with the right intermediate coupling body 48. The left end portion is bolted to a relay bracket 77 provided at the connection point of the left and right receiving net components 73 and 74. The right end portion of the left receiving net component 74 is bolted to the relay bracket 77, and the left end portion is bolted to the second lateral coupling body 58.

Accordingly, by unscrewing the bolts, the left receiving net component 74 can be detached outward to the left through the opening 63 that is opened by removing the lid 64. After removing the left receiving net component 74, by unscrewing the bolts from the relay bracket 77, it is possible to remove the right receiving net component 73.

Threshing Inlet Plate

As shown in FIG. 3, a threshing inlet plate 78, which guides the reaped culm transported by the feeder 12 to the entrance of the threshing chamber 23, is provided below a location on the body-front side corresponding to the raking unit 33 of the threshing cylinder 31. The threshing inlet plate 78 is curved so as to be continuous from the exit of the feeder 12 to the inlet 35 of the threshing chamber 23.

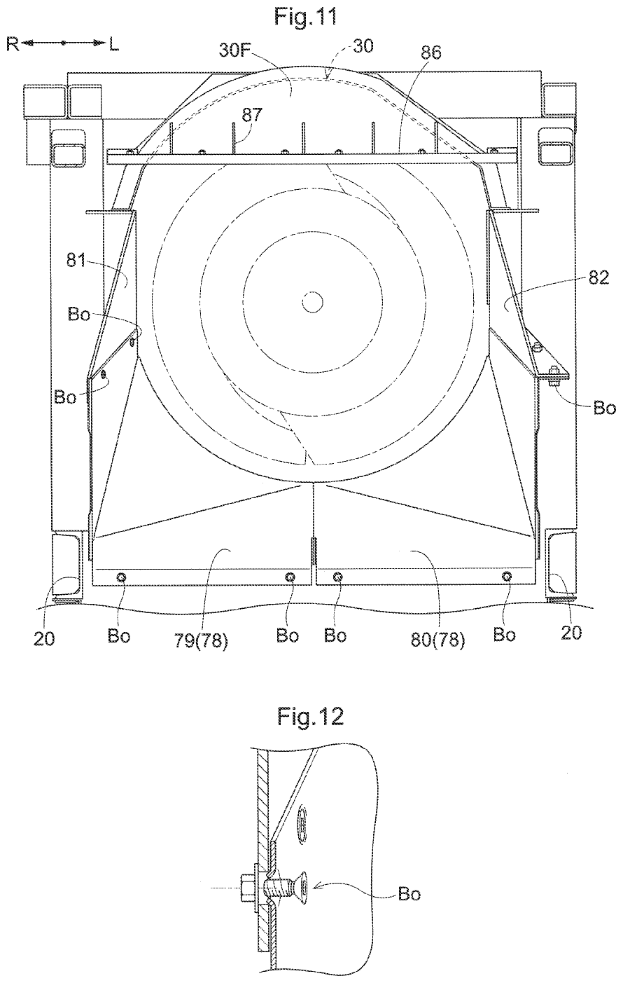

As shown in FIG. 11, the threshing inlet plate 78 is divided into a right divided plate portion 79 and a left divided plate portion 80, at a separation surface in the central portion in the left-right direction. The right divided plate portion 79 of the threshing inlet plate 78 is partially overlapped with and bolted to a right lateral support plate 81. As shown in FIG. 12, a hexagonal hole that can engage with a hexagon wrench is formed in the head portion of a bolt Bo. The bolt head portion has a dish shape and can be screwed so as to not protrude outward. The left divided plate portion 80 is bolted at a vertical flange connection with the left side support plate 82. The front end portions of the left and right divided plate portions 79 and 80 are bolted to a support member (not shown) that is located therebelow and extends in the left-right direction. The left and right divided plate portions 79 and 80 are coupled to each other by horizontal bolts (not shown) at a position below the lateral middle. Although not shown, a sealing member made of sponge or the like is arranged between the left divided plate portion 80 and the left side support plate 82.

Even if the threshing inlet plate 78 becomes worn down due to the flow of a crop, it can be easily removed by unscrewing the bolts. Specifically, after removing the feeder 12 in advance, the right divided plate portion 79 can be detached toward the body-front side by unscrewing the bolts from the lower support member, the right side support plate 81, and the left divided plate portion 80. The left divided plate portion 80 can be detached to the body-front side by unscrewing the bolts from the support member and the right side support plate 82.

Top Plate

The top plate 30 is substantially arc-shaped in a front view so as to substantially follow the rotation path of the outer end portion of the threshing cylinder 31. As shown in FIG. 8, the portion of the top plate 30 located on the right side has a smooth arc shape. The portion of the top plate 30 located on the left side has a flat plate shape. The top plate 30 is integrally formed by portions that are continuous in a series along the circumferential direction.

As described above, the left flange portion 30L of the top plate 30 is placed on and supported by the top plate placement portion 68 on the upper surface of the second lateral coupling body 58, and the right flange portion 30R of the top plate 30 is placed on and supported by the upper surface of the intermediate coupling body 48. A portion (movable top plate portion 83) of the top plate 30 that extends from a location corresponding to the upper portion of the raking unit 33 of the threshing cylinder 31 to a location corresponding to the upper portion of the threshing processing unit 34 of the threshing cylinder 31 can be pulled out in the body-rearward direction from the main body of the threshing device (the portion of the threshing device 4 other than the top plate).

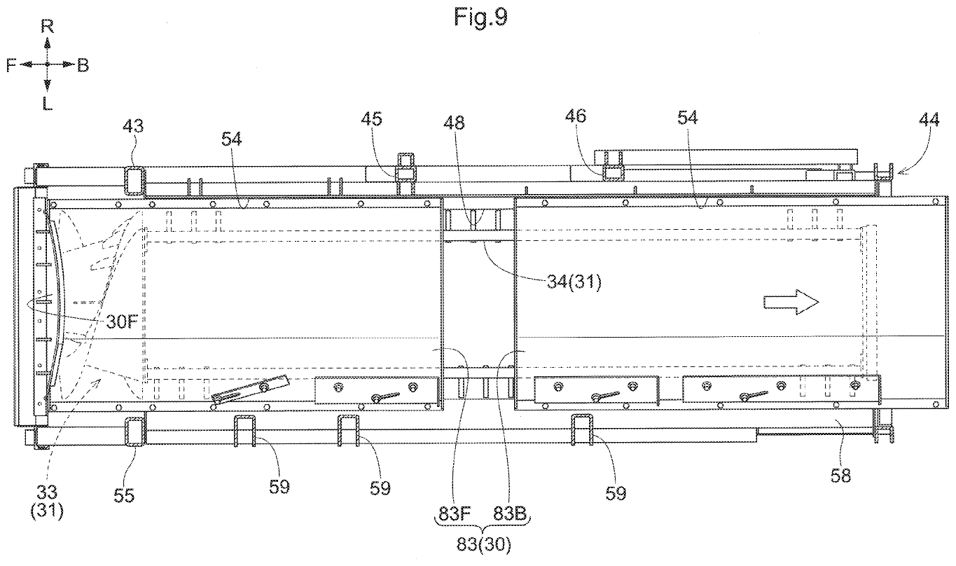

Specifically, as shown in FIG. 9, substantially the entirety of the upper portion of the top plate 30 that covers the upper portion of the threshing cylinder 31 can be pulled out in the body-rearward direction along the rotation axis, and a front wall portion 30F provided in the front end portion of the top plate 30 is fixed to the main body portion of the threshing device (specifically, the front wall portion 29). The movable top plate portion 83 is divided into two parts along the body front-rear direction, namely a front top plate portion 83F and a rear top plate portion 83B.

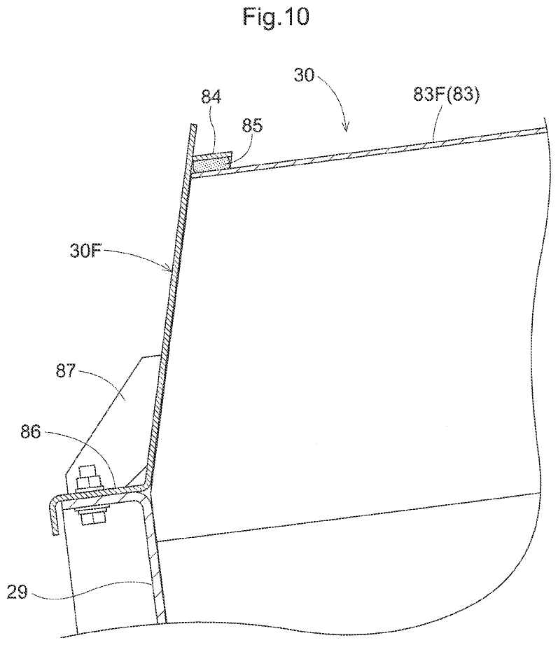

As shown in FIG. 10, a flange portion 84 extends from the front wall portion 30F toward the rear of the body, and the front end portion of the movable top plate portion 83 is closely fitted into the inner surface portion of the flange portion 84. A sealing member 85 made of sponge is disposed between the flange portion 84 and the front end portion of the movable top plate portion 83, over the entire circumference in the circumferential direction. The front wall portion 30F is arranged in a rearward tilted orientation to avoid interference with the cabin 2. Also, a horizontal attachment portion 86 provided at the lower end portion is bolt-fixed to the upper surface of the front wall portion 29 of the threshing device 4. A plurality of reinforcing ribs 87 are provided in a range between the front wall portion 29 and the attachment portion 86.

Also, the movable top plate portion 83 can be pulled out in the body-rear direction along the rotation axis of the threshing cylinder 31. When the movable top plate portion 83 is pulled out, due to the limiting portion 54 provided on the upper surface of the intermediate coupling body 48 and the vertical coupling bodies 59 provided on the upper surface of the second lateral coupling body 58, the top plate 30 is guided so as to not shift in the lateral direction, and thus can smoothly move rearward.

When removing the movable top plate portion 83, first, the exterior cover 17 is swung open laterally outward around the upper portion axis to expose the threshing device 4 laterally outward. Bolts are then unscrewed from the left and right side portions of the movable top plate portion 83 on the body-lateral sides. Next, the rear wall portion 28 of the threshing device 4 is removed, and then the rear top plate portion 83B is pulled out rearward while sliding over the upper surface of the intermediate coupling body 48 and the upper surface of the second lateral coupling body 58 (see FIG. 9). Furthermore, the front top plate portion 83F is slid and pulled out rearward. When the rear top plate portion 83B and the front top plate portion 83F are removed in this way, the space above the threshing cylinder 31 is exposed over a wider range such that maintenance work such as repair and inspection and removal of clogged straw waste and the like can be easily performed on the threshing cylinder 31 from outside the rear of the body or from a lateral side of the body.

The threshing chamber 23 is provided with dust discharge valves 88 that are located on the inward surface side of the top plate 30 and move threshed processed material from the body-front side toward the body-rear side. The dust discharge valves 88 are attached to the inward surface of the top plate 30 and are provided so as to extend substantially spirally at locations on the outer peripheral side of the threshing cylinder 31. In other words, they are provided so as to have a predetermined feed angle so as to transfer the threshed processed material in the body-rear direction relative to the rotation of the threshing teeth 38.

The dust discharge valves 88 each include a fixed dust discharge valve portion 88a that is attached at a fixed position on the top plate 30, and a movable dust discharge valve portion 88b that is circumferentially adjacent to the fixed dust discharge valve portion 88a and can be swung to adjust the feed angle.

As shown in FIG. 8, the fixed dust discharge valve portion 88a is attached to the inner surface of the arc-shaped portion on the right side of the top plate 30, and the movable dust discharge valve portion 88b is attached to the inner surface of the flat plate-shaped portion on the left side of the top plate 30. Although not shown because it is a well-known configuration, the movable dust discharge valve portion 88b is supported so as to be swingable around the axis of the support shaft 89, and the swing angle can be changed and adjusted manually.

### Variations of First Embodiment

(1) In the above embodiment, the front end portion of the movable top plate portion 83 is closely fitted into the inner surface portion of the flange portion 84, which is the flange portion that extends in the body-rear direction from the front wall portion 30F of the top plate 30. Although not shown, instead of this configuration, a configuration may be employed in which the front end portion of the movable top plate portion 83 is closely fitted around the outer surface portion of the flange portion 84.

(2) In the above embodiment, the sealing member 85 is disposed between the flange portion 84 and the front end portion of the movable top plate portion 83, but instead of this configuration, for example, a configuration may be employed in which a tapered surface is formed such that the close fit is gradually achieved when the flange portion 84 and the top plate portion 83 are fitted together.

(3) In the above embodiment, the front wall portion 30F of the top plate 30 is fixed in place, but the front wall portion 30F may also be configured to slide and move together with the movable top plate portion 83.

(4) In the above embodiment, the movable top plate portion 83 is divided into two parts in the front-rear direction, but the present invention is not limited to this configuration, and the movable top plate portion 83 may be integral in the front-rear direction, or alternatively, may be divided into three or more parts.

(5) In the above embodiment, the top plate 30 is substantially arc-shaped when viewed from the front, but instead of this configuration, the following configuration may be used.

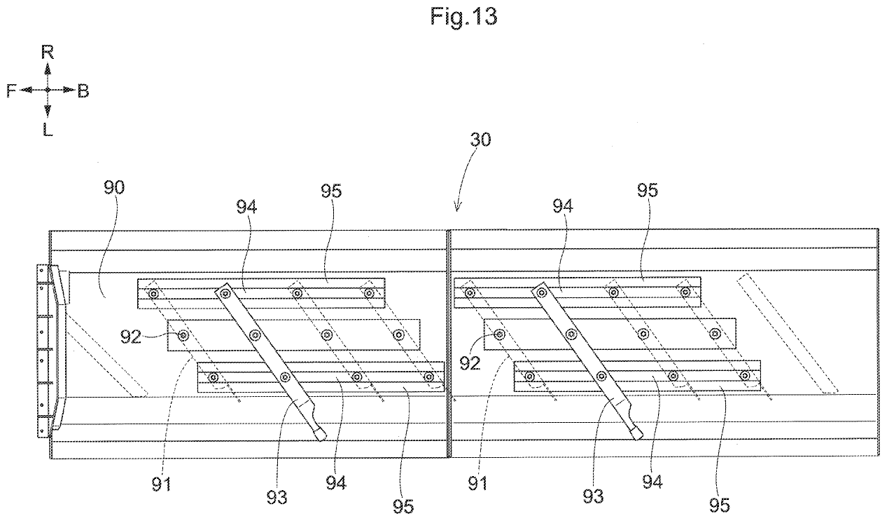

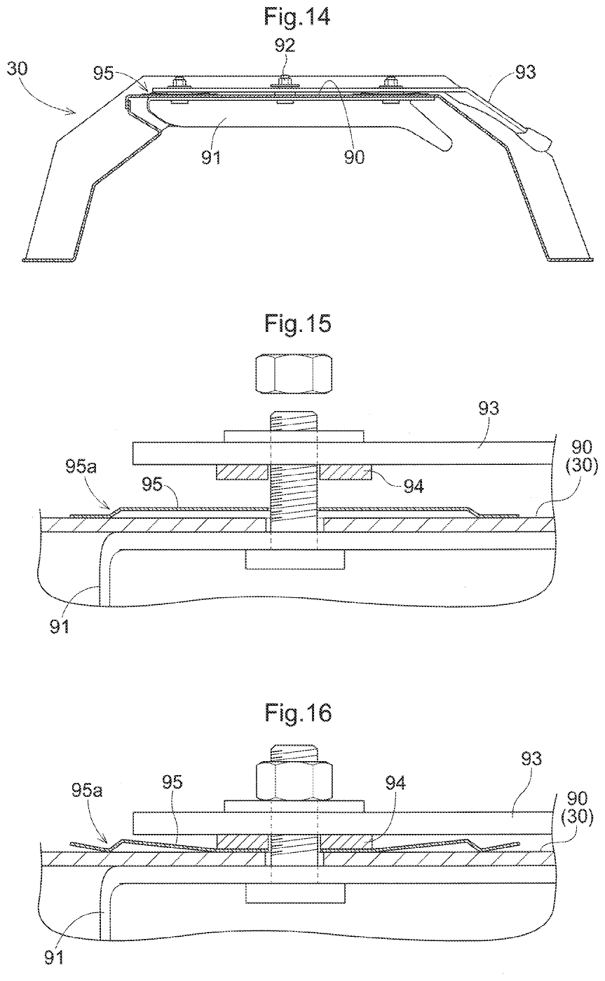

Specifically, as shown in FIGS. 13 and 14, a wide flat surface portion 90 is formed on the upper portion of the top plate 30, and dust discharge valves 91 are provided on the inner surface side of the flat surface portion 90. The dust discharge valves 91 are each provided with a rotation fulcrum 92 in a middle portion in the lateral direction, and the left and right sides swing as a balance to change the feed angle. In order to adjust the angle of the plurality of (four) dust discharge valves 91 in conjunction with each other with one operating tool 93, an interlocking operation member 94 is provided so as to span across the plurality of (four) dust discharge valves 91. A plate-shaped covering member 95 that closes a long hole for adjustment is disposed at bolting locations for coupling the interlocking operation member 94 to the dust discharge valves 91, and the covering member 95 includes bent portions 95a on the two sides in the width direction. As shown in FIGS. 15 and 16, when tightened with a bolt, the central portion deforms so as to be slightly recessed downward, and the two side portions in the width direction come into linear contact. In this configuration, it is possible to reduce frictional resistance in the slide operation while ensuring the function of closing the long holes.

(6) In the above embodiment, the first lateral coupling body 57 is located laterally outward of the second lateral coupling body 58, but instead of this configuration, the first lateral coupling body 57 and the second lateral coupling body 58 may be provided at the same position in the lateral direction, or the first lateral coupling body 57 may be located laterally inward of the second lateral coupling body 58.

(7) In the above embodiment, the upper portion of the second lateral coupling body 58 is wider than the lower portion, but the second lateral coupling body 58 may have the same width on both the upper and lower sides, or the upper portion may be narrower than the lower portion.

(8) In the above embodiment, the top plate placement portion 68 is provided on an upper portion of the second lateral coupling body 58, but instead of this configuration, a dedicated support member for supporting the top plate 30 may be provided.

(9) In the above embodiment, the vertical coupling bodies 59 are located below the bottom screw 5A of the grain tank 5, but instead of this configuration, a configuration is possible in which the vertical coupling bodies 59 are not provided below the bottom screw 5A.

(10) In the above embodiment, the vertical coupling bodies 59 are located below the output shaft 6a of the engine 6, but instead of this configuration, a configuration is possible in which the vertical coupling bodies 59 are not provided below the output shaft 6a of the engine 6.

(11) In the above embodiment, three vertical coupling bodies 59 are provided, but instead of this configuration, one vertical coupling body 59 may be provided, two vertical coupling bodies 59 may be provided, or four or more vertical coupling bodies 59 may be provided.

(12) In the above embodiment, the combine is a normal-type combine, but the present invention is not limited to a normal-type combine, and is applicable to any combine that is provided with a grain tank located above a threshing device, and can also be applied to an autodetachable combine harvester.

### Second Embodiment

The following describes a second embodiment.

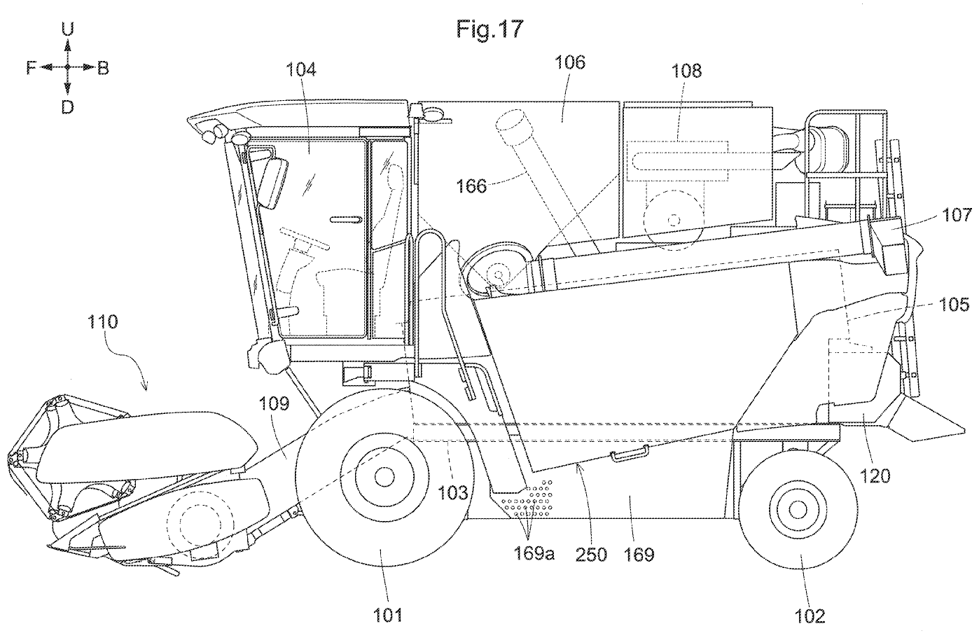

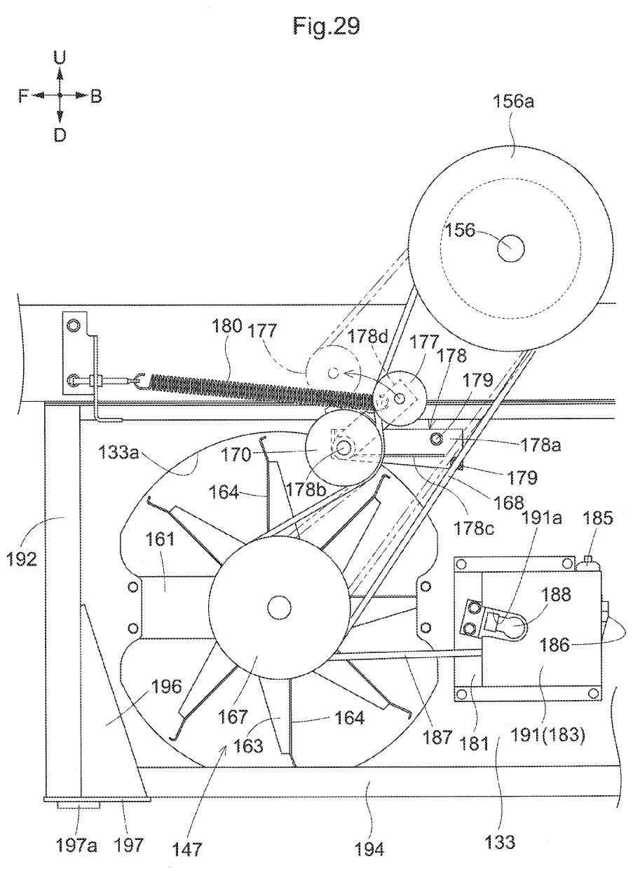

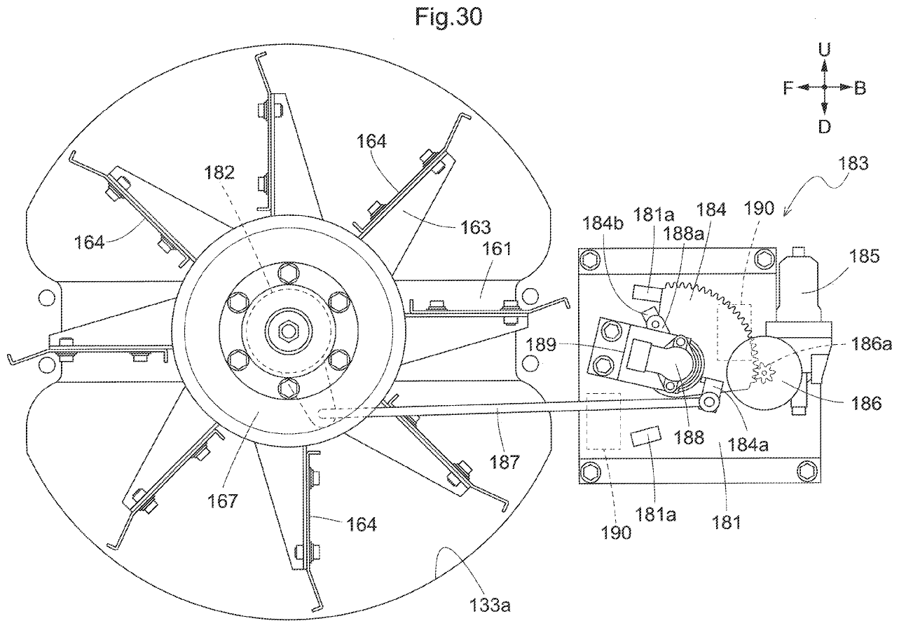

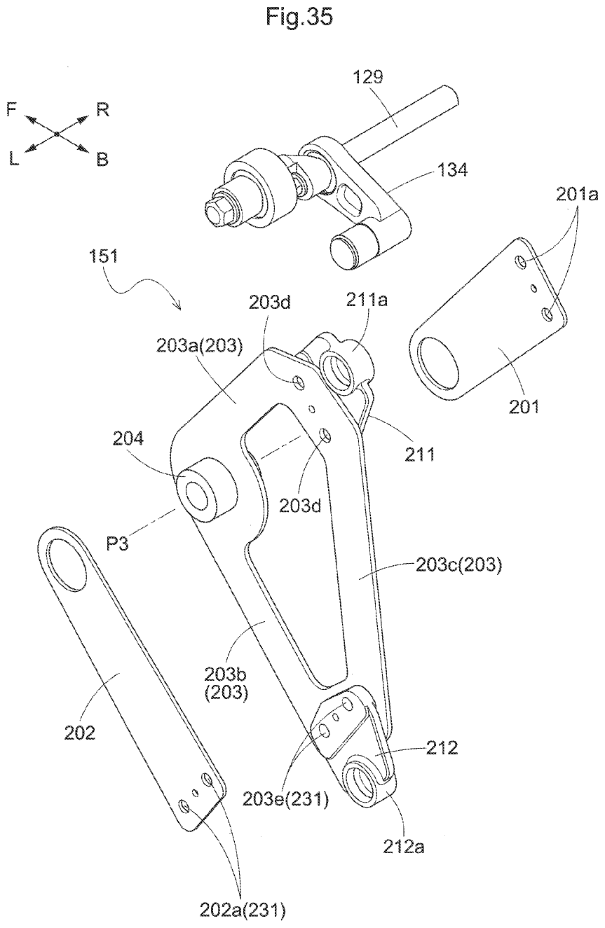

FIGS. 17 to 38 show a normal-type combine equipped with a threshing device of the present invention, where F indicates the forward direction, B indicates the rearward direction, U indicates the upward direction, D indicates the downward direction, R indicates the rightward direction, and L indicates the leftward direction.

Overall Configuration of Combine

As shown in FIG. 17, right and left front wheels 101 are supported by front portions of right and left body frames 103 that extend along the front-rear direction, and right and left rear wheels 102 are supported by rear portions of the body frames 103. A driver portion 104 is provided at a front portion of the body frames 103, and a threshing device 250 is provided on the body frames 103.

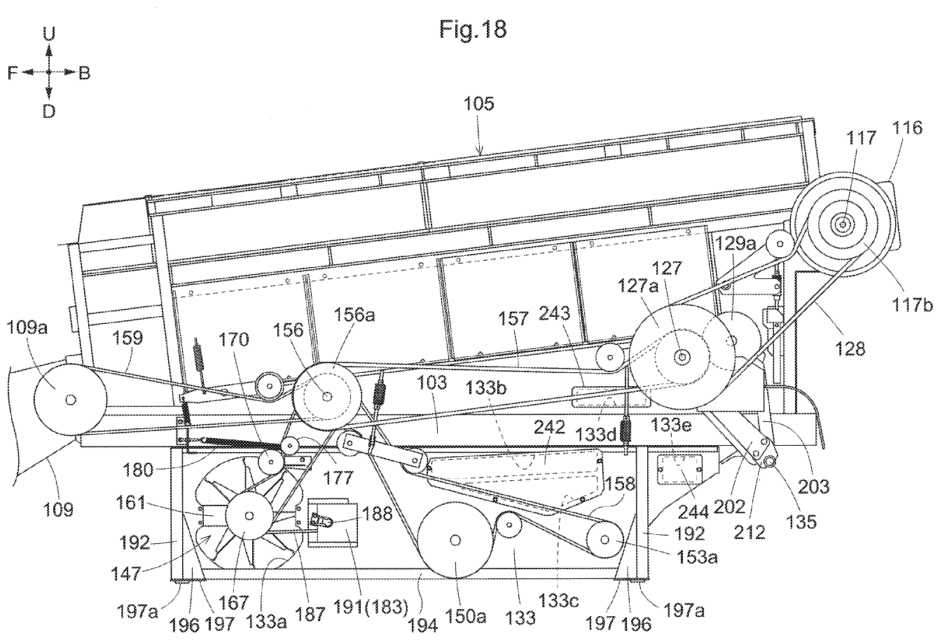

As shown in FIGS. 18, 19, and 20, the threshing device 250 includes a threshing unit 105, a first sorting unit 111, a second sorting unit 112, and the like that are provided between right and left side walls 133.

As shown in FIG. 17, a grain tank 106 is provided above a front portion of the threshing unit 105, the grain tank 106 includes an unloader 107, and an engine 108 is provided above a rear portion of the threshing unit 105. A feeder 109 is provided in front of the threshing unit 105 and extends forward, and a reaping unit 110 is connected to a front portion of the feeder 109.

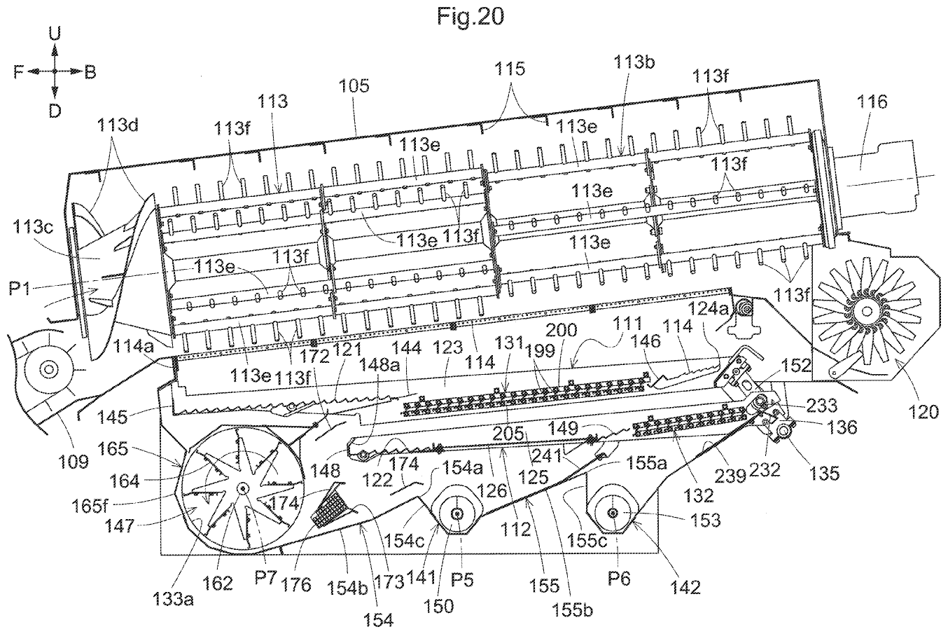

As shown in FIG. 20, the first sorting unit 111 is provided below the threshing unit 105. The second sorting unit 112 is provided below the first sorting unit 111. A clean grain collecting unit 141 is provided below the second sorting unit 112. The tailings collecting unit 142 is provided at a location that is below the second sorting unit 112 and rearward of the clean grain collecting unit 141. A grain fan 147 that supplies sorting wind to the first sorting unit 111 and the second sorting unit 112 is provided at a location that is below a front portion of the threshing unit 105 and forward of the clean grain collecting unit 141.

As shown in FIGS. 17 and 20, a crop in a field is reaped and harvested by the reaping unit 110 and supplied to the threshing unit 105 through the feeder 109. The harvested crop is threshed by the threshing unit 105, and the processed material from the threshing unit 105 is sorted by the first sorting unit 111 and the second sorting unit 112.

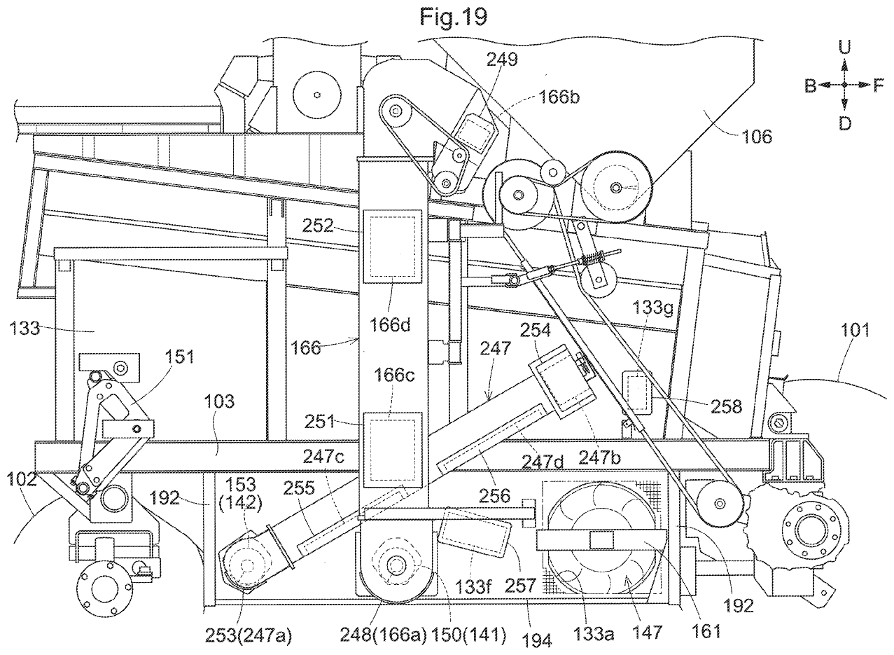

As shown in FIGS. 17 and 19, grain obtained as the sorted processed material is collected by the clean grain collecting unit 141 from the second sorting unit 112 and is supplied to the grain tank 106 by a transport device 166. A mixture of grain, straw waste, and the like obtained as the sorted processed material is collected by the tailings collecting unit 142 from the second sorting unit 112 and supplied to the front portion of the first sorting unit 111 by a transport device 247 and sorted again.

When the grain tank 106 is full of grain, the reaping work is temporarily suspended, the grain in the grain tank 106 is discharged to another transport vehicle (not shown) by the unloader 107, and then the reaping work is restarted.

Configuration of Threshing Unit

As shown in FIG. 20, the threshing unit 105 is provided with a threshing cylinder 113 that is rotationally driven around a rotating axis P1 extending along the front-rear direction, as well as a receiving net 114, a dust discharge valves 115, and the like. The threshing cylinder 113 and the receiving net 114 are arranged with a rearward and upward inclination, and the dust discharge valves 115 are provided above the threshing cylinder 113.

The threshing cylinder 113 is provided with a raking unit 113a for raking the reaped crop rearward, a threshing processing unit 113b that is continuous with a rear portion of the raking unit 113a and threshes the crop, and the like.

The raking unit 113a of the threshing cylinder 113 includes a conical main body portion 113c, and a spiral portion 113d connected to the outer peripheral portion of the main body portion 113c, for example.

The threshing processing unit 113b of the threshing cylinder 113 includes a plurality of round pipe-shaped threshing tooth support portions 113e arranged along the rotation axis P1, and a large number of round bar-shaped threshing teeth 113f that extend radially outward from the threshing tooth support portions 113e, for example.

The receiving net 114 has a large number of lattices formed by a large number of semicircular members that extend along the rotation direction of the threshing cylinder 113 and a large number of rod members that extend along the rotation axis P1. The receiving net 114 is arranged below the threshing processing unit 113b of the threshing cylinder 113, and has a semi-cylindrical shape extending along the threshing processing unit 113b of the threshing cylinder 113.

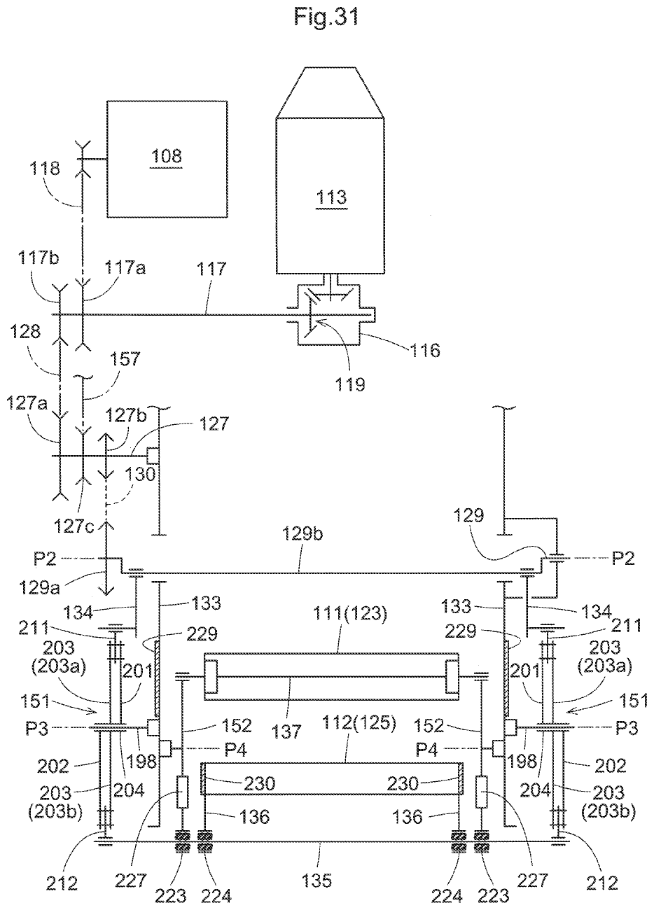

As shown in FIGS. 20 and 31, a drive case 116 is connected to a rear portion of the threshing unit 105, and a transmission shaft 117 protrudes to the left from the drive case 116. Motive power from the engine 108 is transmitted from a pulley 117a connected to a left portion of a transmission shaft 117 to the transmission shaft 117 via a transmission belt 118, and is then transmitted to the threshing cylinder 113 via a bevel gear mechanism 119 inside the drive case 116, and the threshing cylinder 113 is rotationally driven around the rotation axis P1.

As a result, the crop reaped by the reaping unit 110 is transported toward the threshing unit 105 by the feeder 109, is raked rearward by the raking unit 113a of the threshing cylinder 113, and is introduced into the threshing unit 105. The crop is threshed by the threshing cylinder 113 and the receiving net 114, and is sent rearward by the guiding action of the dust discharge valves 115.

Processed material such as grain and straw waste passes through the receiving net 114 and falls to the first sorting unit 111 therebelow. The straw waste and the like that reaches the rear portion of the threshing unit 105 without falling downward through the receiving net 114 is shredded by a shredding device 120 and discharged to the field.

Configuration of Right and Left Side Walls

As shown in FIGS. 18, 19, and 20, the threshing unit 105 is arranged between right and left side walls 133, and the right and left side walls 133 extend below the threshing unit 105 and have the following configuration.

As shown in FIGS. 18, 19, 28, and 29, four support column members 192 are provided, namely two square pipe-shaped support column members 192 that are coupled to and extend downward from a front portion and a rear portion of the right body frame 103, and two square pipe-shaped support column members 192 that are coupled to and extend downward from a front portion and a rear portion of the left body frame 103.

A horizontal frame 193 is coupled to and extends between lower portions of the right and left support column members 192 on the front side, and a horizontal frame 193 is coupled to and extends between lower portions of the right and left support column members 192 on the rear side. A horizontal frame 194 is coupled to and extends between lower portions of the front and rear support column members 192 on the right side, and a horizontal frame 194 is coupled to and extends between lower portions of the front and rear support column members 192 on the left side.

The right side wall 133 is coupled to and extends between the right body frame 103, the front and rear support column members 192 on the right side, and the right horizontal frame 194, and the left side wall 133 is coupled to and extends between the left body frame 103, front and rear support column members 192 on the left side, and the left horizontal frame 194. The outward sides of the threshing unit 105, the first sorting unit 111, and the second sorting unit 112 are covered by the right and left side walls 133.

The configuration described below is provided at a lower portion of each of the four support column members 192.

A bottom plate 197, to which a ring member 197a is coupled, is coupled to and extends between a lower end portion of the support column member 192 and the horizontal frames 193 and 194. A triangular rib 195 is coupled to and extends between the support column member 192 and the horizontal frame 193. A triangular rib 196 is coupled to and extends between the support column member 192, the horizontal frame 194, and the bottom plate 197.

A jack (not shown) can be placed against the bottom of the bottom plate 197, and the combine can be lifted by the jack. The right and left bottom plates 197 on the front side are mainly used when replacing the front wheels 101 or when removing the transmission case (not shown). The right and left bottom plates 197 on the rear side are mainly used when replacing the rear wheels 102.

Configuration of First Sorting Unit

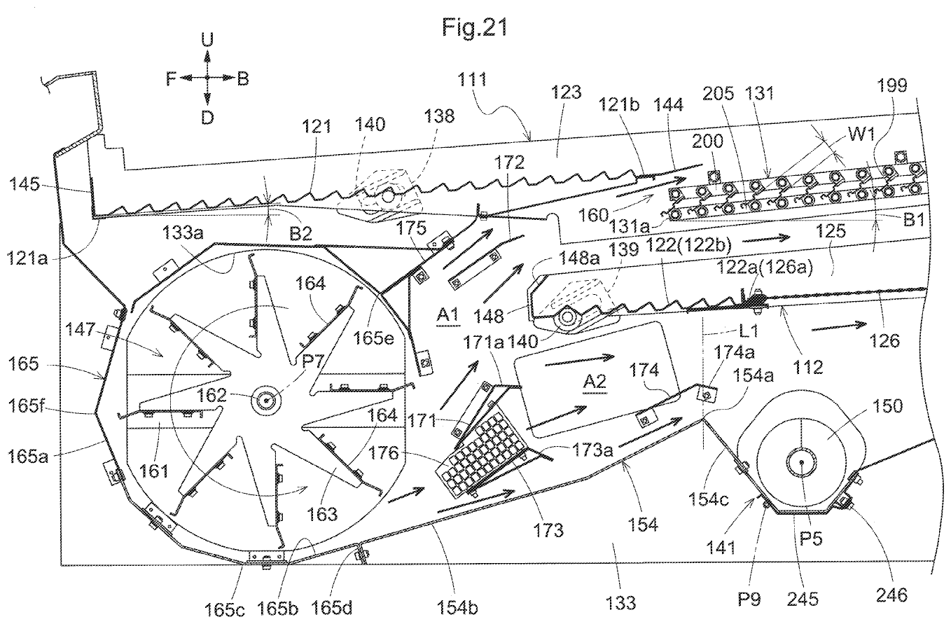

As shown in FIGS. 20 and 21, the first sorting unit 111 for sorting the processed material from the threshing unit 105 is arranged at a position that is below the threshing unit 105 and between the right and left side walls 133, is supported so as to be reciprocally movable along the front-rear direction, and is driven to reciprocate (see the later section “Configuration for reciprocating driving of first sorting unit and the second sorting unit”).

The first sorting unit 111 is provided with a frame-shaped first sieve case 123 that is rectangular in a plan view, and, attached to the first sieve case 123 are, in the following stated order, a first grain pan 121 for transporting processed material rearward, a first chaff sieve 131 for sorting and dropping processed material while transporting it rearward, and a straw rack 124 for sorting and dropping processed material while transporting it rearward, and these members extend from the front portion to the rear portion of the first sorting unit 111.

The first grain pan 121 has a saw-tooth shape in a side view, and is provided at a front portion of the first sorting unit 111 (first sieve case 123) in a rearward and upward inclined orientation extending rearward from the front end portion of the first sorting unit 111 (first sieve case 123).

A large number of elongated round bar-shaped sieving lines 144 are coupled to a rear end portion 121b of the first grain pan 121 at intervals along the left-right direction, and the sieving lines 144 extend rearward in a cantilevered manner from the rear end portion 121b of the first grain pan 121. A wall portion 145 formed higher than the first grain pan 121 is provided at a front end portion 121a of the first grain pan 121.

A front end portion 131a of the first chaff sieve 131 is located below the sieving lines 144, and the front end portion 131a of the first chaff sieve 131 and the sieving lines 144 are overlapped with each other in a plan view. The first chaff sieve 131 is provided in the first sorting unit 111 (first sieve case 123) so as to extend rearward in a rearward and upward inclined orientation from the rear end portion 121b of the first grain pan 121 while being separated therefrom by a gap 160 on the rearward side and the lower side.

A support frame 146 is coupled to the first sieve case 123 along the left-right direction in the vicinity of the rear end portion of the first chaff sieve 131. The straw rack 124 has a saw-tooth shape in a side view, and a large number of straw racks 124 are coupled to the support frame 146 at intervals along the left-right direction, and extend rearward in a cantilevered manner from the support frame 146.

Configuration of First Chaff Sieve

As shown in FIGS. 21, 24, and 25, in the first sorting unit 111, a large number of chaff lips 199 that extend along the left-right direction are arranged side by side along the front-rear direction in the first sieve case 123, thus constituting the first chaff sieve 131.

The flat plate-shaped elongated right and left support members 200 are supported along the front-rear direction on the right and left inner surfaces of the first sieve case 123, and upper portions of the right and left end portions of the chaff lips 199 are supported by the support member 200 so as to be swingable around an axis along the left-right direction.

Flat plate-shaped elongated right and left operating members 205 extend along the front-rear direction on the right and left inner surfaces of the first sieve case 123, and lower portions of the right and left end portions of the chaff lips 199 are connected to the operating member 205 so as to be swingable around an axis along the left-right direction.

The chaff lips 199 are inclined rearward and upward in a side view, and when the positions of the operating members 205 are changed in the front-rear direction, the inclination angle of the chaff lips 199 is changed in conjunction with the operating members 205.

When the positions of the operating members 205 are changed to the rear side, the inclination angle of the chaff lips 199 increases, the chaff lips 199 approach an upright posture, and the size of a gap W1 between adjacent chaff lips 199 increases. When the positions of the operating members 205 are changed to the front side, the inclination angle of the chaff lips 199 decreases, the chaff lips 199 approach a horizontal posture, and the size of the gap W1 between adjacent chaff lips 199 decreases.

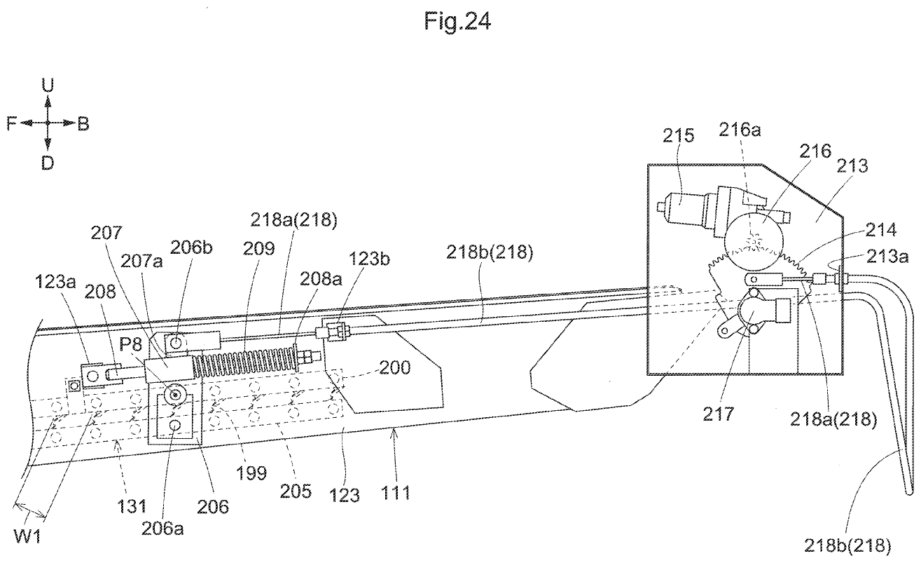

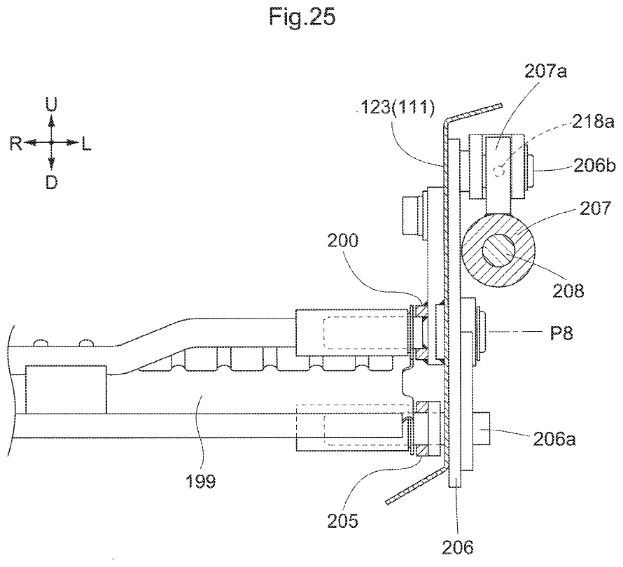

As shown in FIGS. 24 and 25, a plate-like gap changing portion 206 is supported on an outer surface portion of the left portion of the first sieve case 123 so as to be swingable around a swing axis P8 that extends along the left-right direction. An operation pin 206a coupled to a lower portion of the gap changing portion 206 is connected to the left operating member 205 through an opening (not shown) in a left portion of the first sieve case 123.

When the gap changing portion 206 is swung around the swing axis P8, the position of the left operating member 205 is changed in the front-rear direction by the operation pin 206a of the gap changing portion 206, and the position of the right operating member 205 is changed in the front-rear direction via the chaff lip 199.

The gap changing portion 206 is used to operate the first chaff sieve 131 (chaff lips 199) toward an open state such that the size of the gap W1 between adjacent chaff lips 199 increases, or toward a closed state such that the size of the gap W1 decreases.

Configuration for Operating Gap Changing Portion

As shown in FIGS. 24 and 25, a pin-shaped connecting portion 206b is coupled to an upper portion of the gap changing portion 206. A bracket 207a is coupled to a boss portion 207 and is swingably connected to the connecting portion 206b of the gap changing portion 206.

A rod portion 208 that is swingable in the up-down direction is connected to a bracket 123a that is coupled to an outer surface portion of a left portion of the first sieve case 123, and the rod portion 208 is inserted into the boss portion 207 and extends rearward. As a result, the rod portion 208 is connected to the first sorting unit 111 and slidably passes through the boss portion 207.

The rod portion 208 is inserted into a coil spring 209, and the coil spring 209 is provided between the boss portion 207 and a spring receiving portion 208a of the rod portion 208 in a compressed state relative to the free length.

The coil spring 209 operates the gap changing portion 206 in the counterclockwise direction shown in FIG. 24 via the boss portion 207 by extending from the compressed state relative to the free length, and the gap changing portion 206 is biased by the coil spring 209 toward opening via the boss portion 207.

A support plate 213 is coupled to the outer surface portion of the left side wall 133. An operation gear 214 is supported by the support plate 213 so as to be swingable around an axis along the left-right direction, and an electric motor 215 and a gear mechanism 216, which are an actuator, are coupled to the support plate 213. A pinion gear 216a of the gear mechanism 216 is rotationally driven by motive power from the electric motor 215, and the operation gear 214 is swung by the pinion gear 216a of the gear mechanism 216.

One end portion of an outer portion 218b of a wire 218 is connected to a bracket 213a coupled to the support plate 213, and one end portion of an inner portion 218a of the wire 218 is connected to the operation gear 214.

The wire 218 extends rearward from the support plate 213, turns forward, and further extends forward through the space between the left side wall 133 and the left portion of the second sieve case 125. The other end portion of the outer portion 218b of the wire 218 is connected to the bracket 123b that is coupled to the outer surface portion of a left portion of the first sieve case 123, and the other end portion of the inner portion 218a of the wire 218 is connected to the connecting portion 206b of the gap changing portion 206.

Accordingly, the wire 218 is connected to and extends between the electric motor 215 and the gap changing portion 206. The coil spring 209 and the wire 218 (inner portion 218a) are connected to the same upper portion of the gap changing portion 206 that extends from the swing axis P8, and are arranged side by side with each other. The coil spring 209 and the wire 218 (inner portion 218a) are connected to a shared connecting portion 216b provided in the gap changing portion 206.

Operation States of Gap Changing Portion

As shown in FIG. 24, when the operation gear 214 is swung by the electric motor 215 and the inner portion 218a of the wire 218 is pulled toward the electric motor 215, the gap changing portion 206 is swung in the clockwise direction shown in FIG. 24 around the swing axis P8 in resistance to the coil spring 209, and the gap changing portion 206 is operated toward the closed state. Accordingly, the coil spring 209 is compressed by the boss portion 207 and the spring receiving portion 208a of the rod portion 208.

When the operation gear 214 is swung by the electric motor 215 and the inner portion 218a of the wire 218 is returned toward the gap changing portion 206, the coil spring 209 extends and pushes the gap changing portion 206 via the boss portion 207, and thus the gap changing portion 206 is swung in the counter-clockwise direction shown in FIG. 24 around the swing axis P8, and the gap changing portion 206 is operated toward the open state.

A potentiometer-type position sensor 217 is connected to the operation gear 214, and the operating angle of the operation gear 214 is detected by the position sensor 217. Due to the operating angle of the operation gear 214 being detected, the operating position of the gap changing portion 206 is detected, and the size of the gap W1 is detected.

Configuration of Second Sorting Unit

As shown in FIGS. 20, 21, and 22, the second sorting unit 112 for sorting the processed material from the first sorting unit 111 is arranged at a position that is below the first sorting unit 111 and between the right and left side walls 133, is supported so as to be reciprocally movable along the front-rear direction, and is driven to reciprocate (see the later section “Configuration for reciprocating driving of first sorting unit and second sorting unit”).

The second sorting unit 112 is provided with a frame-shaped second sieve case 125 that is rectangular in a plan view, and, attached to the second sieve case 125 are, in the following stated order, a second grain pan 122 for transporting processed material rearward, a grain sieve 126 for dropping the sorted processed material into the clean grain collecting unit 141, and a second chaff sieve 132 for transporting processed material rearward and sorting and dropping it into the tailings collecting unit 142, and these members extend from the front portion to the rear portion of the second sorting unit 112.

The second grain pan 122 has a saw-tooth shape in a side view, and is provided at a front portion of the second sorting unit 112 (second sieve case 125) and extends rearward from the front end portion of the second sorting unit 112 (second sieve case 125). A wall portion 148 formed higher than the second grain pan 122 is provided at a front end portion of the second grain pan 122, and an upper portion 148a of the wall portion 148 faces rearward and diagonally upward.

As will be described later in the section “Configuration of first air passage and first, second, and fifth wind direction members”, a portion of the sorting wind from the grain fan 147 flows rearward between the first sorting unit 111 (rear portion of the first grain pan 121) and the wall portion 148, and thus the wall portion 148 prevents processed material from spilling from the second grain pan 122 to the front side.

The grain sieve 126 is constituted by a punching metal member that is a flat plate-shaped member in which a large number of small openings are formed, and a crimp net formed by woven thin metal wires. The grain sieve 126 is connected to a rear end portion 122a of the second grain pan 122, and is provided in the second sorting unit 112 (second sieve case 125) so as to extend rearward from the rear end portion 122a of the second grain pan 122.

A large number of elongated round bar-shaped sieving lines 149 that are saw-tooth shaped in a side view are coupled to a rear end portion 126b of the grain sieve 126 at intervals along the left-right direction, and the sieving lines 149 extend rearward in a cantilevered manner from the rear end portion 126b of the grain sieve 126.

A front end portion 132a of the second chaff sieve 132 is located slightly rearward away from the rear end portion 126b of the grain sieve 126, and the second chaff sieve 132 is provided in the second sorting unit 112 (second sieve case 125) so as to extend rearward in a rearward and upward inclined state.

Similarly to the first chaff sieve 131 described in the previous section “Configuration of first chaff sieve”, in the second chaff sieve 132, a large number of chaff lips 210 that extend along the left-right direction are arranged side by side along the front-rear direction in the second sieve case 125, thus constituting the second chaff sieve 132.

Similarly to the first chaff sieve 131, the size of the gaps between the chaff lips 210 of the second chaff sieve 132 can be changed by changing the inclination angle of the chaff lips 210 of the second chaff sieve 132. In this case, the worker manually changes the inclination angle (gaps) of the chaff lip 210 by using a tool or the like.

Configuration of Rear End Portion and Rear Wall Portion of Second Sieve Case

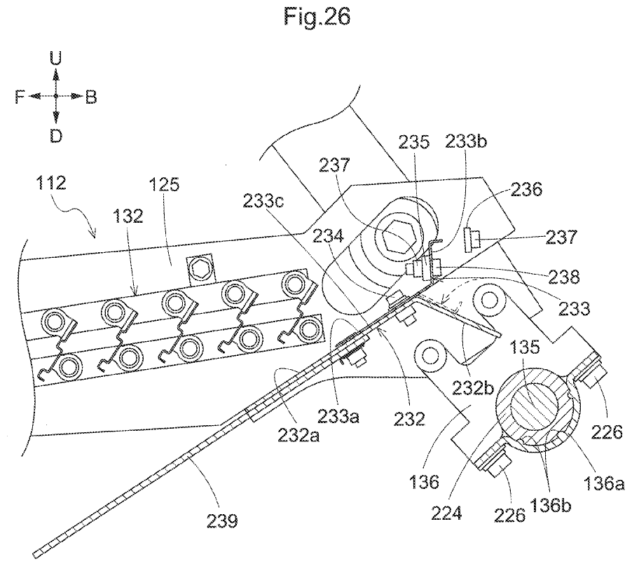

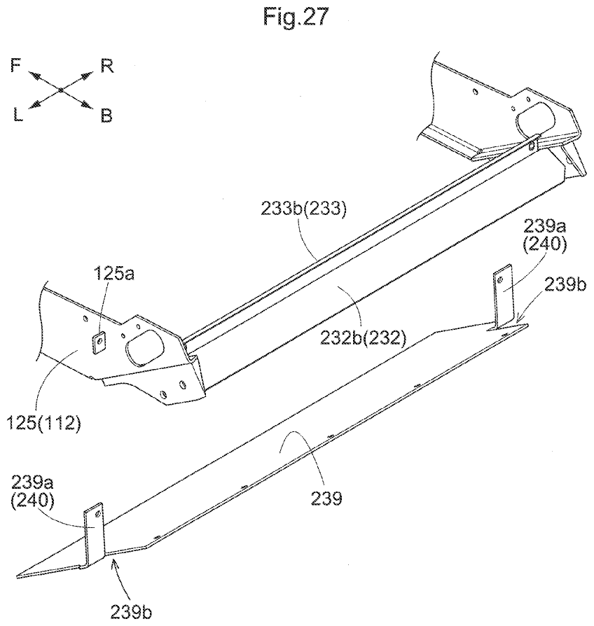

As shown in FIGS. 26 and 27, a rear end portion 232 coupled to the second sieve case 125 has a flat plate shape along the left-right direction, a front portion 232a of the rear end portion 232 is inclined rearward and upward in a side view, and a rear portion 232b of the rear end portion 232 is inclined rearward and downward in a side view.

The front portion 232a of the rear end portion 232 is provided with a rear wall portion 233 that extends between the left and right ends of the second sorting unit 112. The rear wall portion 233 is formed by a bent plate member, the rear wall portion 233 includes a lower portion 233a that extends along the front portion 232a of the rear end portion 232, and an upper portion 233b that extends upward from the lower portion 233a, and an elongated hole 233c that extends in the front-rear direction is formed in the lower portion 233a.

The lower portion 233a of the rear wall portion 233 is slidable along the front portion 232a of the rear end portion 232, and the rear wall portion 233 extends in a rearward and upward inclined direction in a side view and is supported by the rear end portion 232 such that the position can be changed in the front-rear direction and the up-down direction.

When the position of the rear wall portion 233 is moved forward relative to the rear end portion 232, the upper portion 233b of the rear wall portion 233 moves forward and downward. When the position of the rear wall portion 233 is moved rearward relative to the rear end portion 232, the upper portion 233b of the rear wall portion 233 moves rearward and upward.

A bolt 234, which is a position fixing portion, is tightly screwed into a coupling hole in the front portion 232a of the rear end portion 232 and the elongated hole 233c of the rear wall portion 233, and thus the rear wall portion 233 (lower portion 233a) is fixed to the rear end portion 232. By loosening the bolt 234, the rear wall portion 233 (lower portion 233a) is released from being fixed, and the rear wall portion 233 can be moved forward or rearward relative to the rear end portion 232 as described above.

Configuration of Guideline Portion of Second Sieve Case

As shown in FIG. 26, two guideline portions 235 and 236, which indicate positions where the rear wall portion 233 is to be fixed, are coupled to inner surface portions of a right portion and a left portion of a rear portion of the second sieve case 125 with a gap therebetween in the front-rear direction. A nut 237 is coupled to a front surface portion of the guideline portion 235, and a nut 237 is coupled to a rear surface portion of the guideline portion 236.

The right portion of the upper portion 233b of the rear wall portion 233 is arranged between the guideline portions 235 and 236 of the rear right portion of the second sieve case 125, and the left portion of the upper portion 233b of the rear wall portion 233 is arranged between the guideline portions 235 and 236 on the left side of the rear portion of the second sieve case 125.

When the rear wall portion 233 is moved forward or rearward relative to the rear end portion 232, the position where the upper portion 233b of the rear wall portion 233 comes into contact with the guideline portion 235 is the frontmost position of the rear wall portion 233, and the position where the upper portion 233b of the wall portion 233 comes into contact with the guideline portion 236 is the rearmost position of the rear wall portion 233.

The state shown in FIG. 26 is a state in which the rear wall portion 233 is located at the frontmost position, and a bolt 238, which is a connector, is tightly screwed into the upper portion 233b of the rear wall portion 233 and the nut 237 of the guideline portion 235, and the upper portion 233b of the rear wall portion 233 is coupled to the guideline portion 235. Accordingly, the position of the rear wall portion 233 is fixed to the second sieve case 125 by the bolt 234 and the bolt 238.

When the bolt 238 is removed from the state shown in FIG. 26 and the rear wall portion 233 is uncoupled, the position of the rear wall portion 233 can be moved rearward. When the rear wall portion 233 is at the rearmost position, if the bolt 238 is tightly screwed into the upper portion 233b of the rear wall portion 233 and the nut 237 of the guideline portion 236, the upper portion 233b of the rear wall portion 233 becomes coupled to the guideline portion 236.

When the upper portion 233b of the rear wall portion 233 is located between the guideline portions 235 and 236, if the position of the rear wall portion 233 is fixed by the bolt 234, the upper portion 233b of the rear wall portion 233 is not coupled to the guideline portions 235 and 236, and thus the bolt 238 is attached to the nut 237 of the guideline portion 235 or the nut 237 of the guideline portion 236.

When the bolts 234 and 238 are removed, the rear wall portion 233 can be pulled out rearward from the rear end portion 232. Thereafter, the rear wall portion 233 is vertically inverted, and as shown by the dashed line in FIG. 26, the lower portion 233a of the rear wall portion 233 can be placed on the front portion 232a of the rear end portion 232, and the upper portion 233b of the rear wall portion 233 can be placed on the rear portion 232b of the rear end portion 232. This state is close to a state in which the rear wall portion 233 does not exist.

In this state, by tightly screwing the bolt 234 to the coupling hole of the front portion 232a of the rear end portion 232 and the elongated hole 233c of the rear wall portion 233, the rear wall portion 233 becomes fixed to the rear end portion 232. The bolt 238 is attached to the nut 237 of the guideline portion 235 or the nut 237 of the guideline portion 236.

Configuration of Guide Member

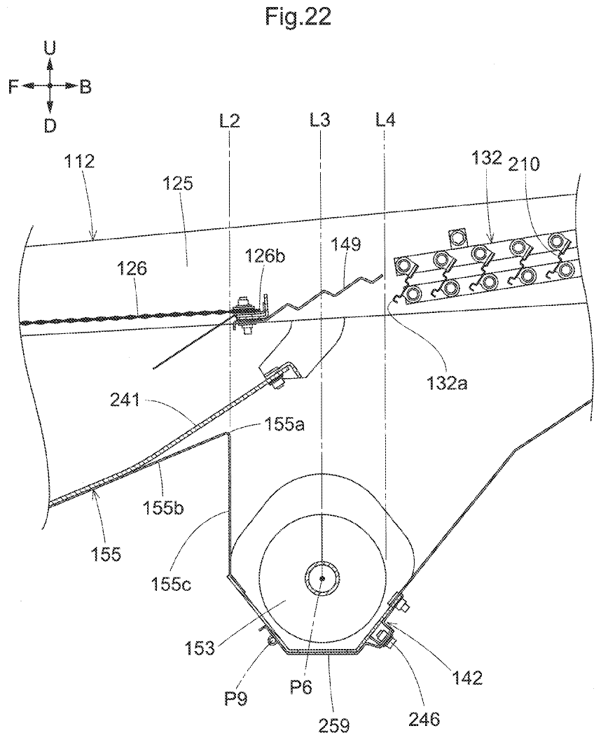

As shown in FIGS. 20 and 22, in the second sorting unit 112, a flat plate-shaped guide member 241 made of a flexible rubber plate extends in a forward and downward inclined state from the position of the rear end portion 126b of the grain sieve 126 toward the clean grain collecting unit 141 that is arranged below the second sorting unit 112. The grain that is the processed material from the second sorting unit 112 is guided to the clean grain collecting unit 141 by the guide member 241.

As shown in FIGS. 20, 26, and 27, a flat plate-shaped guide member 239 made of a flexible rubber plate is coupled to the front portion 232a of the rear end portion 232 of the second sieve case 125 and extends in a forward and downward inclined state toward the tailings collecting unit 142 that is arranged below the second sorting unit 112. A mixture of grain and straw waste or the like, which is the processed material from the second sorting unit 112, is guided to the tailings collecting unit 142 by the guide member 239.

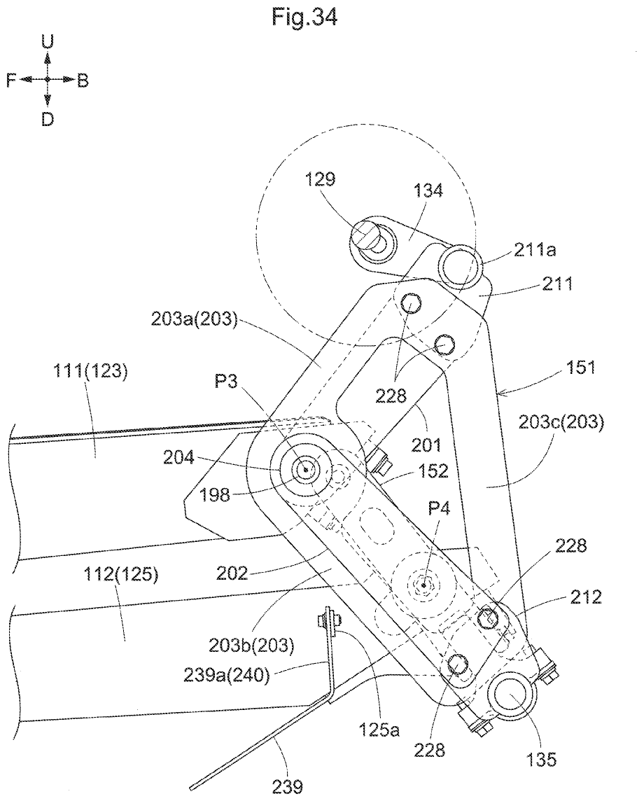

As shown in FIGS. 27 and 34, right and left slits 239b that extend forward from the rear end portion of the guide member 239 are formed in a right portion and a left portion of a rear end portion of the guide member 239. An outer portion 239a rightward of the right slit 239b in the guide member 239 is bent upward to extend between the right portion of the second sieve case 125 and the right side wall 133, and the right portion 239a of the guide member 239 is bolted to the right bracket 125a that is coupled to the second sieve case 125.

An outer portion 239a leftward of the left slit 239b in the guide member 239 is bent upward to extend between the left portion of the second sieve case 125 and the left side wall 133, and the left portion 239a of the guide member 239 is bolted to the left bracket 125a that is coupled to the second sieve case 125.

Right and left leak prevention portions 240 are formed by the right and left portions 239a of the guide member 239, and the leak prevention portion 240 are arranged at positions above the guide member 239 between the second sieve case 125 and the side wall 133.

Accordingly, in the vicinity of the rear portion of the second sieve case 125, the gaps between the second sieve case 125 and the side wall 133 are closed by the leak prevention portions 240, thus suppressing the case where processed material leaks rearward through the gaps between the second sieve case 125 and the side wall 133.

Configuration of Inspection Openings in Right and Left Side Walls

As shown in FIG. 18, the left side wall 133 is provided with inspection openings 133b, 133c, 133d, and 133e and inspection covers 242, 243, and 244.

Removing the inspection cover 242 opens the inspection opening 133b of the upper side wall 133 above the grain sieve 126 in a side view and the inspection opening 133c of the side wall 133 that is below the grain sieve 126 in a side view. When the inspection opening 133b of the side wall 133 is opened, the upper portion of the grain sieve 126 can be inspected and cleaned.

When the inspection opening 133c of the side wall 133 is opened, the lower side of the grain sieve 126 is exposed, and thus when the removed second sorting unit 112 is inserted from the rear side of the combine, the worker can perform operations such that the guide members 239 and 241 (see the previous section “Configuration of guide member”) are appropriately arranged relative to the clean grain collecting unit 141 and the tailings collecting unit 142.

When the inspection cover 243 is removed and the inspection opening 133d of the side wall 133 is exposed, the region including the gap changing portion 206 (see the previous section “Configuration for operating the gap changing portion”) is exposed. The worker can adjust the wire 218, the coil spring 209, and the like.

When the inspection cover 244 is removed and the inspection opening 133e of the side wall 133 is exposed, the region including the second chaff sieve 132 is exposed. The worker can change the inclination angle of the chaff lips 210 of the second chaff sieve 132 (see the previous section “Configuration of second sorting unit”).

As shown in FIG. 19, the right side wall 133 is provided with inspection openings 133f and 133g and inspection covers 257 and 258.

When the inspection cover 257 is removed and the inspection opening 133f of the side wall 133 is exposed, the upper portion of the grain sieve 126 can be inspected and cleaned.

When the inspection cover 258 is removed, the inspection opening 133g of the side wall 133 is opened, and thus when the removed first sorting unit 111 is inserted from the rear side of the combine, the worker can perform operations such that a flexible guide member (not shown) at the front end portion of the threshing unit 105 can be appropriately arranged on the first sorting unit 111.

Configuration of Clean Grain Collecting Unit, Tailings Collecting Unit, and Inspection Openings of Transport Device

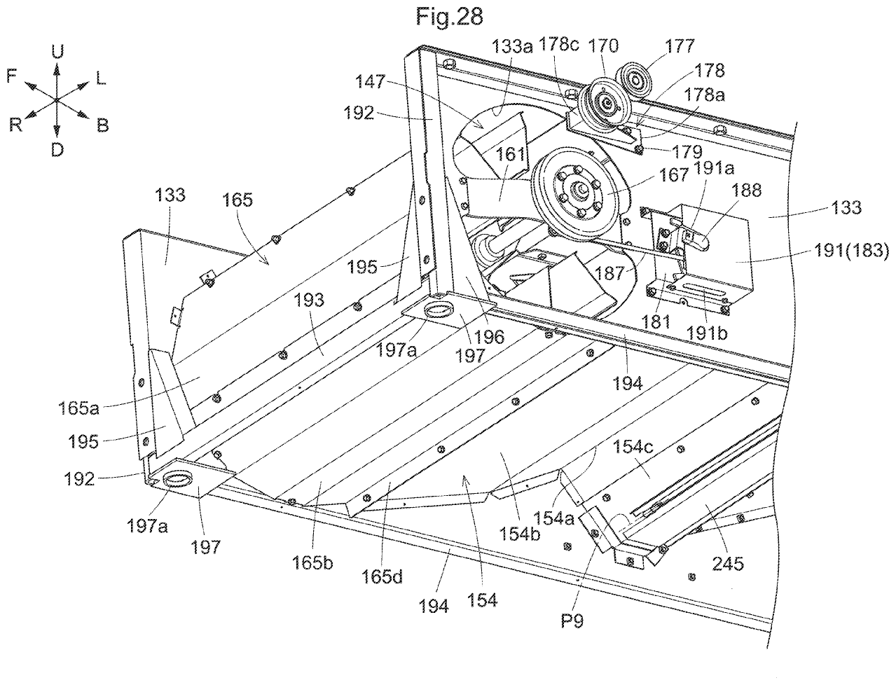

As shown in FIGS. 21 and 28, a front end portion of a bottom plate portion 245 of the clean grain collecting unit 141 is supported so as to be swingably openable and closable around an axis P9 that extends along the left-right direction, and a coupling bolt 246 for fixing the bottom plate portion 245 in the closed state is provided at a rear end portion of the bottom plate portion 245.

By removing the coupling bolt 246 and opening the bottom plate portion 245 downward, the clean grain collecting unit 141 can be inspected and cleaned. As shown in FIG. 22, a bottom plate portion 259 of the tailings collecting unit 142 is configured similarly to the bottom plate portion 245 of the clean grain collecting unit 141.

As shown in FIG. 19, the transport device 166 that supplies the grain collected by the clean grain collecting unit 141 to the grain tank 106 is provided with inspection openings 166a, 166b, 166c, and 166d that are located in a lower portion, an upper portion, and an intermediate portion of the transport device 166.

A swingable open/close type of inspection cover 248 covers the inspection opening 166a of the transport device 166, a removable open/close type of inspection cover 249 covers the inspection opening 166b of the transport device 166, a removable open/close type of inspection cover 251 covers the inspection opening 166c of the transport device 166, and a removable open/close type of inspection cover 252 covers the inspection opening 166d of the transport device 166.

The transport device 247 that supplies a mixture of grain, straw waste, and the like collected by the tailings collecting unit 142 to a front portion of the first sorting unit 111 is provided with inspection openings 247a, 247b, 247c, and 247d that are located in a lower portion, an upper portion, and an intermediate portion of the transport device 247.

A swingable open/close type of inspection cover 253 covers the inspection opening 247a of the transport device 247, a removable open/close type of inspection cover 254 covers the inspection opening 247b of the transport device 247, a swingable open/close type of inspection cover 255 covers the inspection opening 247c of the transport device 247, and a swingable open/close type of inspection cover 256 covers the inspection opening 247d of the transport device 247.

Configuration of Grain Fan

As shown in FIGS. 20 and 21, the front portion of the first sorting unit 111 extends forward such that the front portion of the first sorting unit 111 is located in front of the front portion of the second sorting unit 112. The grain fan 147 is provided below the front portion of the threshing unit 105, and is arranged at a location that is below the front portion of the first sorting unit 111 and forward of the front portion of the second sorting unit 112.

As shown in FIGS. 18 and 19, a circular opening 133a is formed in a front portion of each of the right and left side walls 133, and flat right and left support frames 161 are coupled to and extend between a front portion and a rear portion of the openings 133a of the side walls 133.

As shown in FIGS. 21, 23, and 30, a drive shaft 162 is rotatably supported by and extends between the right and left support frames 161, and right and left support plates 163 that are star-shaped in a side view are coupled to the drive shaft 162. A blade plate 164 is coupled to each arm portion of the right and left support plates 163, and the blade plates 164 have a flat plate shape and are slightly bent in a side view. The grain fan 147 is rotationally driven around an axis P7 that extends along the left-right direction of the drive shaft 162 in the counterclockwise direction show in FIG. 21.

As shown in FIGS. 21 and 28, a grain fan case 165 is provided above, in front of, and below the grain fan 147, the outward side of the grain fan 147 is covered by the grain fan case 165, and the grain fan case 165 is provided with a front case portion 165a and a rear case portion 165b.

A right end portion of the front case portion 165a of the grain fan case 165 is coupled to an inner surface portion of the right side wall 133, and a left end portion of the front case portion 165a of the grain fan case 165 is coupled to an inner surface portion of the left side wall 133. A front end portion 114a of the receiving net 114 and a front end portion 165f of the grain fan case 165 (front case portion 165a) are arranged at the same position in the front-rear direction. A plurality of small openings 165c for draining water are formed in a bottom portion of the rear case portion 165b of the grain fan case 165.

As shown in FIG. 17, a synthetic resin cover 169 is provided on the outside of the left side wall 133. A large number of small openings 169a are formed in a portion of the cover 169 that faces the opening 133a of the left side wall 133.

According to the above configuration, when the grain fan 147 is driven to rotate, air is introduced into the grain fan 147 through the openings 133a of the side walls 133, sorting wind from the grain fan 147 moves diagonally upward and rearward from the vicinity of the lower portion of the grain fan 147, and passes between the right and left side walls 133 and is supplied to the first sorting unit 111 and the second sorting unit 112 as described in the later sections “Configuration of first air passage and first, second, and fifth wind direction members” and “Configuration of second air passage and third, fourth, and sixth wind direction members”.

Configurations of Clean Grain Collecting Unit, Tailings Collecting Unit, Front Partition Unit, and Rear Partition Unit

As shown in FIGS. 20 and 21, a transport screw 150 is provided in the clean grain collecting unit 141 so as to be rotatable around a screw axis P5 that extends along the left-right direction. A transport screw 153 is provided in the tailings collecting unit 142 so as to be rotatable around a screw axis P6 that extends along the left-right direction.

As shown in FIGS. 20, 21, and 28, a mountain-shaped front partition unit 154 that projects upward in a side view is provided between the clean grain collecting unit 141 and the grain fan 147. The front partition unit 154 includes a bottom portion 154b that extends diagonally forward and downward from a peak portion 154a, and an inclined portion 154c that extends diagonally rearward and downward from the peak portion 154a.

The inclined portion 154c of the front partition unit 154 is connected to a lower portion of the clean grain collecting unit 141, and the clean grain collecting unit 141 is provided at a location that is below the second sorting unit 112 and rearward of the peak portion 154a, which is the rear end portion of the bottom portion 154b of the front partition unit 154.

The bottom portion 154b of the front partition unit 154 is coupled to the lower end portion 165d of the grain fan case 165 (rear end portion of the case portion 165b), and the bottom portion 154b of the front partition unit 154 extends rearward from the lower end portion 165d of the grain fan case 165 (rear end portion of the case portion 165b).

The front end portion of the rear case portion 165b of the grain fan case 165 is placed on the front side of a lower end portion of the front case portion 165a of the grain fan case 165 and bolted thereto. A front end portion of the bottom portion 154b of the front partition unit 154 and the lower end portion 165d of the rear case portion 165b of the grain fan case 165 are bent downward and abutted against each other, and are bolted together along the front-rear direction. By removing the bolts, the rear case portion 165b of the grain fan case 165 can be replaced with another case portion 165b.

As shown in FIGS. 20 and 22, a mountain-shaped rear partition unit 155 that projects upward in a side view is provided between the clean grain collecting unit 141 and the tailings collecting unit 142. The rear partition unit 155 includes a bottom portion 155b that extends diagonally forward and downward from a peak portion 155a, and a vertical wall portion 155c that extends downward from the peak portion 155a. The bottom portion 155b of the rear partition unit 155 is connected to a lower portion of the clean grain collecting unit 141, and the vertical wall portion 155c of the rear partition unit 155 is connected to a front portion and a lower portion of the tailings collecting unit 142.

Configurations of First Air Passage and First, Second, and Fifth Wind Direction Members

As shown in FIGS. 20, 21, and 23, a flat plate-shaped first wind direction member 171, which is an upward wind direction member, is provided at a position that is rearward of the grain fan 147 and at the same height as the drive shaft 162. The first wind direction member 171 extends between the right and left side walls 133, is inclined rearward and upward such that the front portion of the first wind direction member 171 is lower than the rear portion, and a rear end portion 171a of the first wind direction member 171 extends approximately horizontally.

A fifth wind direction member 175 extends diagonally upward and rearward from the upper end portion 165e of the grain fan case 165. A first air passage A1 is formed between the first wind direction member 171 and the fifth wind direction member 175, and a second air passage A2 is formed between the first wind direction member 171 and the bottom portion 154b of the front partition unit 154.

Sorting wind from the grain fan 147 is branched by the first wind direction member 171 is guided to the first air passage A1, and is guided by the first air passage A1 so as to pass between the first sorting unit 111 and the second sorting unit 112.

Sorting wind from the grain fan 147 is branched by the first wind direction member 171, is guided to the second air passage A2, and, as described later in the section “Configuration of second air passage and third, fourth, and sixth wind direction members”, is guided by the second air passage A2 from below the second sorting unit 112 to the second sorting unit 112.

A flat plate-shaped second wind direction member 172 is arranged at a position that is below a front portion of the first sorting unit 111 and forward of a front portion of the second sorting unit 112, and is arranged between a fifth wind direction member 175 and the wall portion 148 of the second sorting unit 112. The second wind direction member 172 extends between the right and left side walls 133, and is inclined rearward and upward such that the front portion of the second wind direction member 172 is lower than the rear portion.

Out of the sorting wind in the first air passage A1, the sorting wind in the first air passage A1 that passes above the second wind direction member 172 flows along the bottom portion of the first grain pan 121 and is guided to the gap 160.

The sorting wind in the first air passage A1 that passes below the second wind direction member 172 passes between the second wind direction member 172 and the wall portion 148 provided at the front end portion of the second sorting unit 112, and is guided between the first sorting unit 111 and the second sorting unit 112.

Configurations of Second Air Passage and Third, Fourth, and Sixth Wind Direction Members

As shown in FIGS. 20, 21, and 23, a flat plate-shaped third wind direction member 173, which is a lower wind direction member, is provided at a location that is rearward of the grain fan 147 and below the first wind direction member 171, and extends between the right and left side walls 133.

The third wind direction member 173 is in a rearward and upward inclined state in which the front portion of the third wind direction member 173 is lower than the rear portion, and extends along the bottom portion 154b of the front partition unit 154, and a rear end portion 173a of the third wind direction member 173 extends downward.

A flat plate-shaped fourth wind direction member 174 is provided at a position spaced rearward from the rear end portion 173a of the third wind direction member 173, and extends between the right and left side walls 133. The fourth wind direction member 174 is in a rearward and upward inclined state in which the front portion of the fourth wind direction member 174 is lower than the rear portion, and extends along the bottom portion 154b of the front partition unit 154. A rear end portion 174a of the fourth wind direction member 174 extends downward and is located above the peak portion 154a of the front partition unit 154.

Right and left sixth wind direction members 176 are arranged between the first wind direction member 171 and the third wind direction member 173. The sixth wind direction member 176 has a flat plate shape and is provided with a large number of openings, is in an inclined state in which the rear portion of the sixth wind direction member 176 is closer to the lateral center portion between the right and left side walls 133 than the front portion is, and is coupled to the first wind direction member 171 and the third wind direction member 173.

Sorting wind from the grain fan 147 is branched by the first wind direction member 171 and guided to the second air passage A2, sorting wind in the second air passage A2 passes between the first wind direction member 171 and the third wind direction member 173, flows along the bottom portion of the second grain pan 122, and is guided to the bottom portion of the grain sieve 126, and is then guided from below the second sorting unit 112 to the second sorting unit 112.

When the sorting wind in the second air passage A2 passes between the first wind direction member 171 and the third wind direction member 173, the sorting wind in the second air passage A2 (grain fan 147) flowing along the right side wall 133 is guided toward the lateral center portion between the right and left side walls 133 by the right sixth wind direction member 176, and the sorting wind in the second air passage A2 (grain fan 147) that has passed through the openings in the right sixth wind direction member 176 flows along the right side wall 133.

When the sorting wind in the second air passage A2 passes between the first wind direction member 171 and the third wind direction member 173, the sorting wind in the second air passage A2 (grain fan 147) flowing along the left side wall 133 is guided toward the lateral center portion between the right and left side walls 133 by the left sixth wind direction member 176, and the sorting wind in the second air passage A2 (grain fan 147) that has passed through the openings in the left sixth wind direction member 176 flows along the left side wall 133.

A portion of the sorting wind in the second air passage A2 is branched by the third wind direction member 173, and the sorting wind branched from the second air passage A2 is guided by the third wind direction member 173 so as to flow along the bottom portion 154b of the front partition unit 154, and is guided by the fourth wind direction member 174 so as to flow along the bottom portion 154b of the front partition unit 154.

Accordingly, the sorting wind flowing along the bottom portion 154b of the front partition unit 154 (the sorting wind branched from the second air passage A2) passes between the third wind direction member 173 and the bottom portion 154b of the front partition unit 154, and between the fourth wind direction member 174 and the bottom portion 154b of the front partition unit 154, and is guided to an upper portion of the clean grain collecting unit 141.

When the sorting wind flowing along the bottom portion 154b of the front partition unit 154 (the sorting wind branched from the second air passage A2) flows from a position between the third wind direction member 173 and the bottom portion 154b of the front partition unit 154 to a position between the fourth wind direction member 174 and the bottom portion 154b of the front partition unit 154, it can be expected that air from a position between the third wind direction member 173 and the fourth wind direction member 174 will merge with the sorting wind flowing along the bottom portion 154b of the front partition unit 154 (the sorting wind branched from the second air passage A2).

Configuration of Rotational Driving of Transport Screws of Clean Grain Collecting Unit and Tailings Collecting Unit

As shown in FIGS. 18 and 31, the transmission shaft 127 is rotatably supported by a rear portion of the left side wall 133, and a transmission belt 128 is wound around a pulley 117b coupled to a left portion of the transmission shaft 117 and a pulley 127a coupled to the transmission shaft 127.

A relay shaft 156 is rotatably supported by the left side wall 133, and a transmission belt 157 is wound around a pulley 156a coupled to the relay shaft 156 and a pulley 127c coupled to the transmission shaft 127.

A pulley 150a is coupled to a right end portion of the transport screw 150, and a pulley 153a is coupled to a right end portion of the transport screw 153. A transmission belt 158 is wound around a pulley (not shown) coupled to the relay shaft 156, the pulley 150a of the transport screw 150, and the pulley 153a of the transport screw 153. A transmission belt 159 is wound around a pulley (not shown) coupled to the relay shaft 156 and a pulley 109a provided on a left portion of the feeder 109.

As described above in the section “Configuration of threshing unit”, motive power transmitted to the transmission shaft 117 is transmitted to the relay shaft 156 via the transmission shaft 127 and the transmission belts 128 and 157, and is transmitted to the transport screws 150 and 153 via the transmission belt 158, and thus the transport screws 150 and 153 are driven to rotate. The motive power transmitted to the relay shaft 156 is transmitted to the pulley 109a of the feeder 109 via the transmission belt 159, and is transmitted from the feeder 109 to the reaping unit 110.

According to the above configuration, when grain that is the sorted processed material falls from the second sorting unit 112 to the clean grain collecting unit 141, the grain is collected by the rotating transport screw 150 and transported to the right side wall 133, and is then supplied from an outlet in the right side wall 133 to the grain tank 106 by the transport device 166 (see FIG. 19).

When a mixture of grain, straw waste, and the like, which is the sorted processed material, falls from the second sorting unit 112 to the tailings collecting unit 142, the mixture is collected by the rotating transport screw 153 and transported to the right side wall 133, and is then supplied from an outlet in the right side wall 133 to a front portion of the first sorting unit 111 by the transport device 247 (see FIG. 19).

Configuration of Rotational Driving of Grain Fan

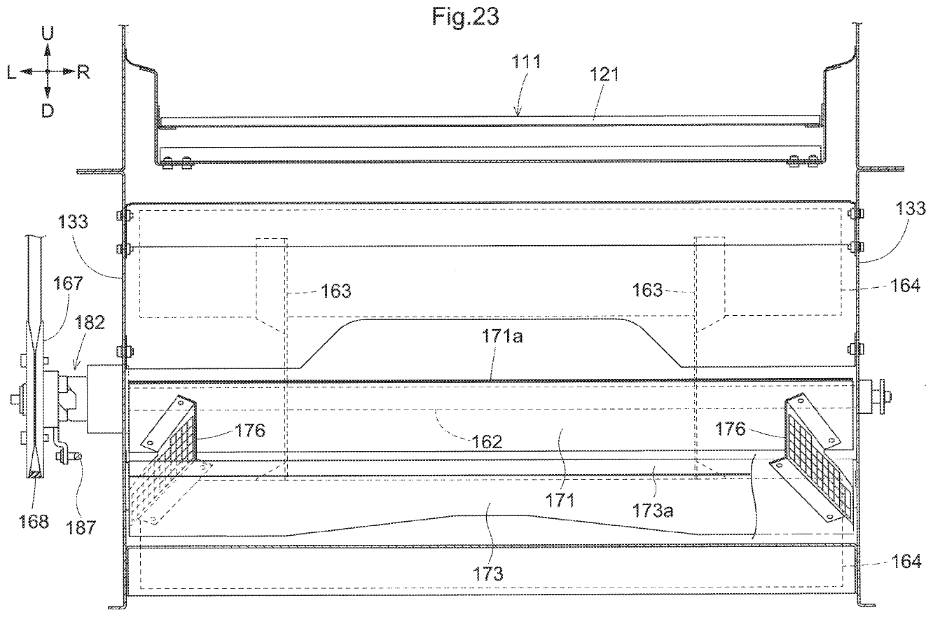

As shown in FIGS. 18 and 23, in the grain fan 147, a divided pulley type of variable pulley 167 is attached to a left end portion of the drive shaft 162, and a transmission belt 168 is wound around a pulley (not shown) coupled to the relay shaft 156 and the variable pulley 167. Motive power transmitted to the relay shaft 156 is transmitted to the variable pulley 167 via the transmission belt 168, and thus the grain fan 147 is driven to rotate in the counterclockwise direction shown in FIG. 18.

The rotation speed of the grain fan 147 can be changed by changing the distance between the opposing pulley portions of the variable pulley 167 so as to change the radius of contact between the transmission belt 168 and the variable pulley 167.

When the distance between the pulley portions of the variable pulley 167 is reduced, the radius of contact between the transmission belt 168 and the variable pulley 167 increases, the grain fan 147 is driven to rotate at a lower speed, and the air volume produced by the grain fan 147 decreases. This state is suitable for when the amount of processed material is small.

When the distance between the pulley portions of the variable pulley 167 is increased, the radius of contact between the transmission belt 168 and the variable pulley 167 decreases, the grain fan 147 is driven to rotate at a higher speed, and the air volume produced by the grain fan 147 increases. This state is suitable for when the amount of processed material is large.

As shown in FIGS. 18, 28, and 29, two tension pulleys 170 and 177 are provided for the transmission belt 168. A support portion 178 supports the tension pulleys 170 and 177, and the support portion 178 is coupled to a portion of the outer surface portion of the left side wall 133 that is adjacent to a rear portion of an upper portion of the opening 133a of the side wall 133.

As described above in the section “Configuration of grain fan”, a right end portion and a left end portion of the grain fan case 165 are coupled to inner surface portions of the right and left side walls 133. The support portion 178 is coupled to a portion of the outer surface portion of the left side wall 133 that faces the inner surface portion of the left side wall 133 to which the left end portion of the grain fan case 165 is coupled.

The support portion 178 includes a flat plate-shaped base plate 178a, a fulcrum shaft 178b coupled to the base plate 178a, an angle-bent reinforcing plate 178c coupled to the base plate 178a and the fulcrum shaft 178b, an arm 178d that is supported so as to be swingable around the fulcrum shaft 178b, and the like.

The base plate 178a of the support portion 178 is coupled to an outer surface portion of the side wall 133 by a plurality of bolts 179, and a tension spring 180 is attached to the arm 178d of the support portion 178. The tension pulley 170 is rotatably supported by the fulcrum shaft 178b of the support portion 178, and the tension pulley 177 is rotatably supported by the arm 178d of the support portion 178.

As described above, if the distance between the pulley portions of the variable pulley 167 is changed and the radius of contact between the transmission belt 168 and the variable pulley 167 is changed, the arm 178d of the support portion 178 and the tension pulley 177 swing in response so as to maintain the tension of the transmission belt 168.

Configuration of Rotation Speed Changing Portion for Changing Rotation Speed of Grain Fan to Change Air Volume of Sorting Wind from Grain Fan

As shown in FIGS. 23, 27, 28, and 29, a reinforcing member 181 formed by bending a plate member into a channel shape is arranged at the same height position as the drive shaft 162 and the support frame 161 at a position rearward of the grain fan 147, and is coupled to an outer surface portion of the left side wall 133.

As described above in the section “Configuration of first air passage and first, second, and fifth wind direction members” and “Configuration of second air passage and third, fourth, and sixth wind direction members”, right and left end portions of the first wind direction member 171 and right and left end portions of the third wind direction member 173 are coupled to inner surface portions of the right and left side walls 133.

In this case, the first wind direction member 171 and the third wind direction member 173 extend between an inner surface portion facing the reinforcing member 181 on the left side wall 133 to which the reinforcing member 181 is coupled, and an inner surface portion facing the reinforcing member 181 on the right side wall 133.

A gap changing mechanism 182 that can change the distance between the pulley portions of the variable pulley 167 is provided at a base portion of the variable pulley 167. The rotation speed changing portion 183 is supported by the reinforcing member 181, and when the gap changing mechanism 182 is operated by the rotation speed changing portion 183, the rotation speed of the grain fan 147 is changed, and the air volume of the sorting wind from the grain fan 147 is changed.

The rotation speed changing portion 183 is provided with an operation gear 184, an electric motor 185, a gear mechanism 186, an operation rod 187, a position sensor 188, and the like. The operation gear 184 is supported by the reinforcing member 181 so as to be swingable around an axis along the left-right direction, and the electric motor 185 and the gear mechanism 186 are coupled to the reinforcing member 181. The operation rod 187 is connected to and extends between a bracket 184a provided on the operation gear 184 and the gap changing mechanism 182.

The pinion gear 186a of the gear mechanism 186 is driven to rotate by motive power from the electric motor 185, the operation gear 184 is swung by the pinion gear 186a of the gear mechanism 186, the operation rod 187 is pushed and pulled, and thus the gap changing mechanism 182 is operated by the operation rod 187. Two stopper portions 181a are coupled to the reinforcing member 181, and the positions where the operation gear 184 is stopped by the stopper portions 181a of the reinforcing member 181 are the operating limits of the gap changing mechanism 182.

An angled support bracket 189 is coupled to the reinforcing member 181, and a potentiometer type of position sensor 188 is supported by the support bracket 189. A detection arm 188a capable of swinging around the same axis as the axis on which the operation gear 184 swings is provided on the position sensor 188, and the detection arm 188a of the position sensor 188 is connected to the bracket 184b of the operation gear 184. When the operation gear 184 is swung, the detection arm 188a of the position sensor 188 swings in conjunction, and the position of the operation gear 184 is detected by the position sensor 188.

A relay switch 190 for operating the electric motor 185 is coupled to an inner surface portion of the reinforcing member 181 and is arranged between an outer surface portion of the left side wall 133 and the reinforcing member 181.

A cover 191 that is bent in a channel shape is coupled to the reinforcing member 181, and the rotation speed changing portion 183 is covered by the cover 191. The front portion of the cover 191 is open, and the operation rod 187 passes through the front portion of the cover 191. The rear portion of the cover 191 is open, and the electric motor 185 and the gear mechanism 186 each protrude from the rear portion of the cover 191 by a small amount.

A cutout portion 191a is provided in the front portion of the cover 191, and the position sensor 188 protrudes from the cutout portion 191a of the cover 191. An opening 191b for discharging small waste matter or the like is formed in a lower portion of the cover 191.

Configuration for Reciprocating Driving of First Sorting Unit and Second Sorting Unit

As shown in FIGS. 31, 33, and 34, a crank shaft 129 serving as a drive unit is supported by and extends between the right and left side walls 133 and can rotate around the axis P2 extending along the left-right direction, and a transmission chain 130 is wound around a sprocket 127b coupled to the transmission shaft 127 and a sprocket 129a coupled to the crank shaft 129.

Right and left fulcrum shafts 198 are coupled to the right and left side walls 133. Right and left drive members 151, which are first drive mechanisms, are supported by the fulcrum shafts 198 so as to be able to reciprocally swing around an axis P3 extending along the left-right direction, and are arranged outward of the right and left side walls 133. An interconnecting link 134 is connected to and extends between a crank portion 129b that is shifted from the axis P2 of the crank shaft 129 and upper portions of the right and left drive members 151.

An interconnecting shaft 135 is coupled to and extends between lower portions of the right and left drive members 151. Right and left connecting members 136 are connected to the interconnecting shaft 135, the right and left connecting members 136 are coupled to a rear portion of the second sorting unit 112 (second sieve case 125), and the drive member 151 is connected to the second sorting unit 112 (second sieve case 125).

Right and left drive arms 152, which are second drive mechanisms, are supported by the right and left side walls 133 so as to be able to reciprocally swing around an arm axis P4 extending along the left-right direction, and are arranged inward of the right and left side walls 133. The drive arms 152 are shaped as a balance and extend to one side and the other side from the arm axis P4.

An interconnecting shaft 137 is rotatably supported by and extends between portions of the right and left drive arm 152 that are on one side of the arm axis P4, a rear portion of the first sorting unit 111 (first sieve case 123) is coupled to the interconnecting shaft 137, and the portions of the drive arms 152 on the one side of the arm axis P4 are connected to the first sorting unit 111 (first sieve case 123).

The portions of the drive arms 152 on the other side of the arm axis P4 are connected to the interconnecting shaft 135, and the portions of the drive arm 152 on the other side of the arm axis P4 are connected to the second sorting unit 112 (second sieve case 125) via the interconnecting shaft 135 and the connecting members 136.

As shown in FIG. 21, guide portions 138 and 139 are coupled to inner surface portions of the right and left side walls 133 and extend along the front-rear direction. A roller 140 is supported by right and left portions of a front portion of the first sorting unit 111 (first sieve case 123), and the roller 140 is supported by the guide portion 138. A roller 143 is supported by right and left portions of a front portion of the second sorting unit 112 (second sieve case 125), and the roller 143 is supported by the guide portion 139.

The front portion of the first sorting unit 111 and the front portion of the second sorting unit 112 are supported by the guide portions 138 and 139 and the rollers 140 and 143 so as to be able to reciprocally move along the front-rear direction. The rear portion of the first sorting unit 111 and the rear portion of the second sorting unit 112 are supported so as to be able to reciprocally move along the front-rear direction due to reciprocal swinging of the drive arm 152 around the arm axis P4. In this way, the first sorting unit 111 and the second sorting unit 112 are supported so as to be able to reciprocally move along the front-rear direction.

Configuration of Tension Wheel Body Provided for Transmission Chain

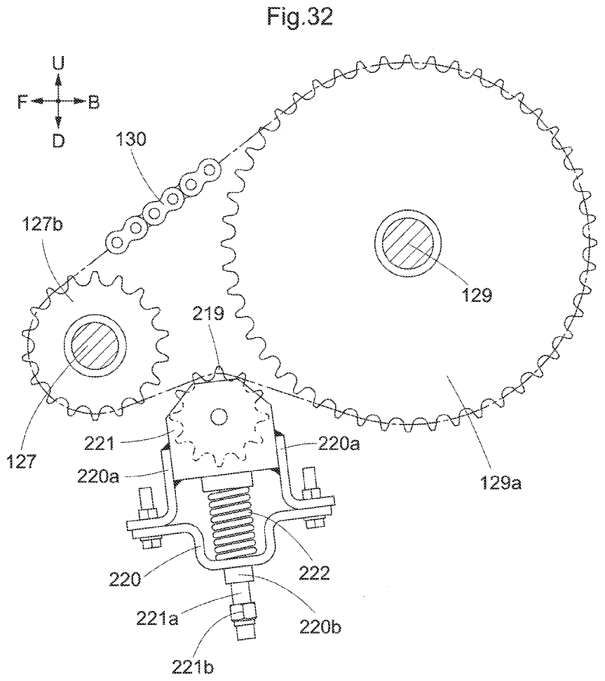

As shown in FIGS. 31 and 32, a tension wheel body 219 for maintaining the tension of the transmission chain 130 is provided below the transmission chain 130. A support member 220 bent into a channel shape is coupled to the left side wall 133, and a pair of angle-shaped guide portions 220a are coupled to the support member 220.

The tension wheel body 219 is supported by a channel-shaped wheel body support portion 221 so as to be rotatable around an axis along the left-right direction, and the wheel body support portion 221 can move vertically between the guide portions 220a of the support member 220. A guide rod 221a coupled to the wheel body support portion 221 is inserted into a boss portion 220b of the support member 220 and can slide up and down, and a retaining nut 221b is attached to a lower portion of the guide rod 221a of the wheel body support portion 221.

The guide rod 221a of the wheel body support portion 221 is inserted into a coil-shaped spring 222, and the spring 222 is provided between the wheel body support portion 221 and the support member 220 in a state of being compressed relative to the free length.

When the spring 222 attempts to extend from the compressed state relative to the free length, the tension wheel body 219 and the wheel body support portion 221 are pushed up by the biasing force of the spring 222, the tension wheel body 219 is pushed against the lower portion of the transmission chain 130, and thus the tension of the transmission chain 130 is maintained. In this case, the wheel body support portion 221 is guided by the guide portions 220a of the support member 220, and the wheel body support portion 221 moves up and down stably without tilting.

Configuration of Drive Member

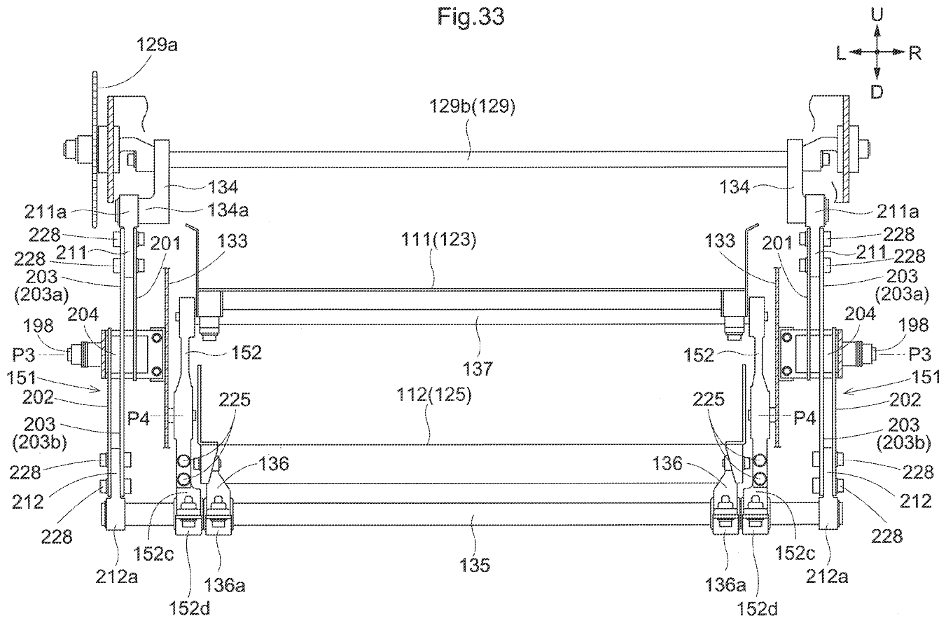

As shown in FIGS. 33, 34, and 35, the right and left drive members 151 each include a first member 201, a second member 202, a third member 203, boss portions 204, a first connecting portion 211, a second connecting portion 212, and the like. The right and left drive members 151 have a triangular shape in a side view, and are configured to be left-right symmetrical with each other.

The boss portions 204 are rotatably supported by the fulcrum shaft 198 and can rotate around the axis P3.

The first member 201 is plate-shaped with a width in the swing direction that is larger than the width in the direction orthogonal to the swing direction, and coupling holes 201a are formed in an end portion. The first member 201 is coupled to one of the boss portions 204 and is supported so as to be swingable around the axis P3.

The second member 202 is plate-shaped with a width in the swing direction that is larger than the width in the direction orthogonal to the swing direction, and coupling holes 202a are formed in an end portion. The second member 202 is coupled to the same boss portion 204 to which the first member 201 is coupled, and is supported so as to be swingable around the axis P3.

The third member 203 has a triangular shape in a side view and includes a portion 203a that extends along the first member 201, a portion 203b that extends along the second member 202, and a portion 203c that extends between a connection portion where the crank shaft 129 and the first member 201 are connected and a connection portion where the second sorting unit 112 (interconnecting shaft 135) and the second member 202 are connected, for example. Coupling holes 203d are formed in end portions of the portions 203a and 203c of the third member 203, and coupling holes 203e are formed in end portions of the portions 203b and 203c of the third member 203.

The portions 203a, 203b, and 203c of the third member 203 are plate-shaped with a width in the swing direction that is larger than the width in the direction orthogonal to the swing direction, and the portions 203a, 203b, and 203c of the third member 203 are integrally formed as a single member. The portions 203a and 203b of the third member 203 are coupled to the same boss portions 204 to which the first member 201 and the second member 202 are coupled, and are supported so as to be swingable around the axis P3.

The first member 201 and the second member 202 are coupled to the boss portions 204 with a gap between each other in a direction along the axis P3, and the first member 201 is arranged closer to the left-right center portion of the first and second sorting units 111 and 112 (closer to the side wall 133) than the second member 202 is. The third member 203 is arranged between the first member 201 and the second member 202 in a front view and in a rear view, and the portions 203a and 203b of the third member 203 are coupled to the boss portions 204.

The first connecting portion 211 is arranged between an end portion of the first member 201 and an end portion of the third member 203 (portions 203a and 203c) in a front view and in a rear view. Bolts 228 are tightly screwed into the coupling holes 201a of the first member 201, the coupling holes 203d of the third member 203, and the first connecting portion 211, and thus the first connecting portion 211 is coupled to the end portion of the first member 201 and the end portion of the third member 203 (portions 203a and 203c).

A connecting shaft 134a of the interconnecting link 134 is connected to a boss portion 211a of the first connecting portion 211, and the crank shaft 129 and the first connecting portion 211 are coupled via the interconnecting link 134.

The second connecting portion 212 is arranged between an end portion of the second member 202 and an end portion of the third member 203 (portions 203b and 203c) in a front view and in a rear view. Bolts 228 are tightly screwed to the coupling holes 202a of the second member 202, the coupling holes 203e of the third member 203, and the second connecting portion 212, and thus the second connecting portion 212 is coupled to the end portion of the second member 202 and the end portion of the third member 203 (portions 203b and 203c).

The interconnecting link 134 is connected to and extends between the crank portion 129b of the crank shaft 129 and the boss portion 211a of the first connecting portion 211, and thus the crank shaft 129 and the drive member 151 are connected to each other.

The interconnecting shaft 135 is connected to a boss portion 212a of the second connecting portion 212, and the second sorting unit 112 and the second connecting portion 212 are connected via the interconnecting shaft 135.

Configuration of Connection Portion Between Drive Arm and Interconnecting Shaft

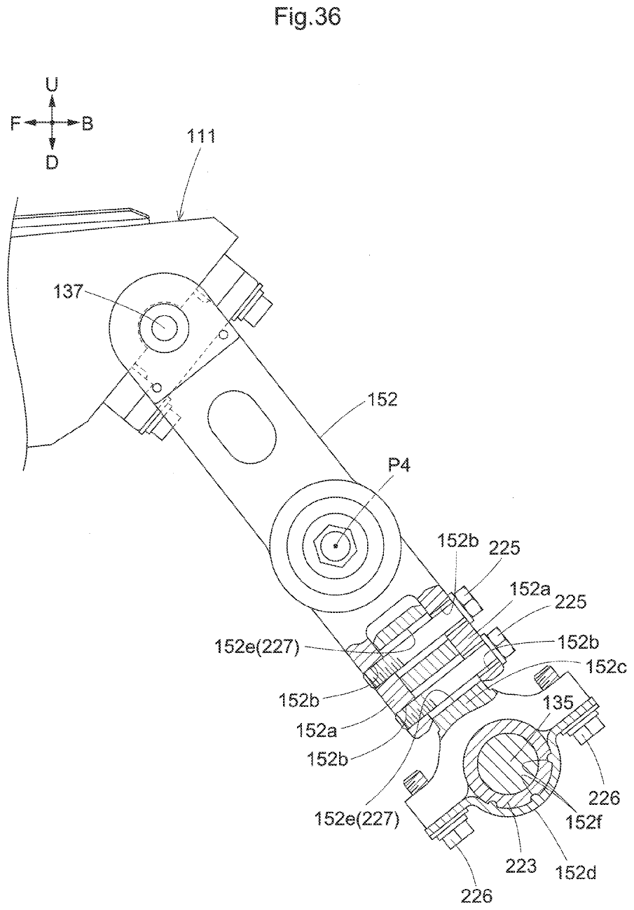

As shown in FIG. 36, a pair of square bar-shaped coupling portions 152a are provided in a lower portion of the drive arm 152, and a coupling hole 152b is formed in each of the coupling portions 152a. A connecting portion 152c and a connecting portion 152d are provided in a lower portion of the drive arm 152.

The connecting portion 152c of the drive arm 152 is formed as a rod-shaped portion that is integrally formed with a semicircular portion, and a coupling hole 152e having an elongated cross section is formed in the rod-shaped portion. The connecting portion 152d of the drive arm 152 has a semicircular shape.

The connecting portion 152c is inserted between the coupling portions 152a of the drive arm 152, bolts 225 are tightly screwed into the coupling holes 152b and 152e of the drive arm 152, and thus the connecting portion 152c is coupled to the coupling portion 152a of the drive arm 152.

An arm length adjusting portion 227 is constituted by the coupling hole 152e of the drive arm 152, and the length of the drive arm 152 from the arm axis P4 to the connection portion connected to the second sorting unit 112 (interconnecting shaft 135) can be adjusted within an extent defined by the coupling hole 152e of the drive arm 152.

A rubber cylindrical elastic body 223 is attached to the interconnecting shaft 135. The elastic body 223 is sandwiched between the connecting portions 152c and 152d of the drive arm 152, and bolts 226 are tightly screwed into the connecting portions 152c and 152d of the drive arm 152, and thus the drive arm 152 and the interconnecting shaft 135 are connected and sandwich the elastic body 223.

A plurality of protruding portions 152f are provided on the inner surface of the connecting portion 152d of the drive arm 152, and flange-shaped stopper portions (not shown) that face the interconnecting shaft 135 are provided at end portions of the connecting portion 152d of the drive arm 152 in the direction along the interconnecting shaft 135.

As described above, while the elastic body 223 is sandwiched between the connecting portions 152c and 152d of the drive arm 152, the protruding portions 152f of the connecting portion 152d of the drive arm 152 dig into the outer surface portion of the elastic body 223, and the stopper portions of the connecting portion 152d of the drive arm 152 abut against the end portion of the elastic body 223, thus preventing positional deviation of the elastic body 223.

Configuration of Connection Portion Between Connecting Member and Interconnecting Shaft

As shown in FIGS. 26 and 33, a semicircular connecting portion 136a is provided at a lower portion of the connecting member 136, and a rubber cylindrical elastic body 224 is attached to the interconnecting shaft 135. The elastic body 224 is sandwiched by the connecting portion 136a of the connecting member 136, bolts 226 are tightly screwed into the connecting portion 136a of the connecting member 136, and thus the connecting member 136 and the interconnecting shaft 135 are connected, with the elastic body 224 arranged therebetween.

The connecting portion 136a of the connecting member 136 is provided with protruding portions 136b and stopper portions (not shown) that are similar to the protruding portions 152f and the stopper portions of the connecting portion 152d of the drive arm 152.

Accordingly, the elastic body 223 is provided at the connection portion where the drive arm 152 and the second sorting unit 112 are connected, and the elastic bodies 223 and 224 are provided at the connection portion where the drive member 151 and the second sorting unit 112 are connected.

As shown in FIG. 31, instead of both of the elastic bodies 223 and 224 being provided, the elastic body 223 may be provided, and the elastic body 224 may be omitted. The elastic body 224 may be provided, and the elastic body 223 may be omitted. The elastic body 223 may be provided at the connection portion where the drive member 151 (second connecting portion 212) and the interconnecting shaft 137 are connected.

Configuration of Wear Prevention Member Provided Between Side Wall and Drive Arm/Drive Member

As shown in FIG. 31, at the right drive member 151 and the right side wall 133, and at the left drive member 151 and the left side wall 133, the drive member 151 (first member 201) and the side wall 133 are close to each other.

A wear prevention member 229 having excellent wear resistance is attached to a portion of the outer surface portion of the side wall 133 that faces the swing range of the drive member 151 (first member 201), and the wear prevention member 229 is arranged between the drive member 151 and the side wall 133 that covers the outward side of the first sorting unit 111 and the second sorting unit 112.

In this case, the wear prevention member 229 may be attached to the drive member 151 (first member 201) instead of being attached to the side wall 133, or may be attached to both the side wall 133 and the drive member 151 (first member 201).

At the right portion of the rear portion of the right drive arm 152 and the second sorting unit 112 (second sieve case 125), and at the left portion of the rear portion of the left drive arm 152 and the second sorting unit 112 (second sieve case 125), the drive arm 152 and the second sorting unit 112 (second sieve case 125) are close to each other.

A wear prevention member 230 having excellent wear resistance is attached to a portion of the outer surface portion of the rear portion of the second sorting unit 112 (second sieve case 125) that faces the swing range of the drive arm 152, and the wear prevention member 230 is arranged between the drive arm 152 and the second sorting unit 112.

In this case, the wear prevention member 230 may be attached to the drive arm 152 instead of being attached to the second sorting unit 112 (second sieve case 125), or may be attached to both the second sorting unit 112 (second sieve case 125) and the drive arm 152.

A configuration is possible in which the wear prevention member 230 is attached to a portion of the outer surface of the rear portion of the first sorting unit 111 (first sieve case 123) that faces the swing range of the drive arm 152, and the wear prevention member 230 is arranged between the drive arm 152 and the first sorting unit 111.

In this case, the wear prevention member 230 may be attached to the drive arm 152 instead of being attached to the first sorting unit 111 (first sieve case 123), or may be attached to both the first sorting unit 111 (first sieve case 123) and the drive arm 152.

Instead of providing both of the wear prevention members 229 and 230 as described above, the wear prevention member 229 may be provided, and the wear prevention member 230 may be omitted. The wear prevention member 230 may be provided, and the wear prevention member 229 may be omitted.

Reciprocating Driving of First Sorting Unit and Second Sorting Unit

Based on the above-described section “Configuration for reciprocating driving of first sorting unit and second sorting unit”, the first sorting unit 111 and the second sorting unit 112 are driven to reciprocate in opposite directions along the front-rear direction as described below.

As shown in FIGS. 31, 37, 38, motive power from the engine 108 is transmitted to the transmission shaft 117 via the transmission belt 118 (see the previous section “Configuration of threshing unit”), is transmitted to the transmission shaft 127 via the transmission belt 128, and is transmitted to the crank shaft 129 via the transmission chain 130.

When the crank shaft 129 is driven to rotate, the drive member 151 is driven to reciprocally swing around the axis P3 via the interconnecting link 134, and the second sorting unit 112 is driven by the drive member 151 to reciprocate along the front-rear direction via the interconnecting shaft 135 and the connecting member 136.

Due to the second sorting unit 112 reciprocating in the front-rear direction, the drive arm 152 is reciprocally swung around the arm axis P4 via the interconnecting shaft 135, and the first sorting unit 111 is driven to reciprocate in the front-rear direction.

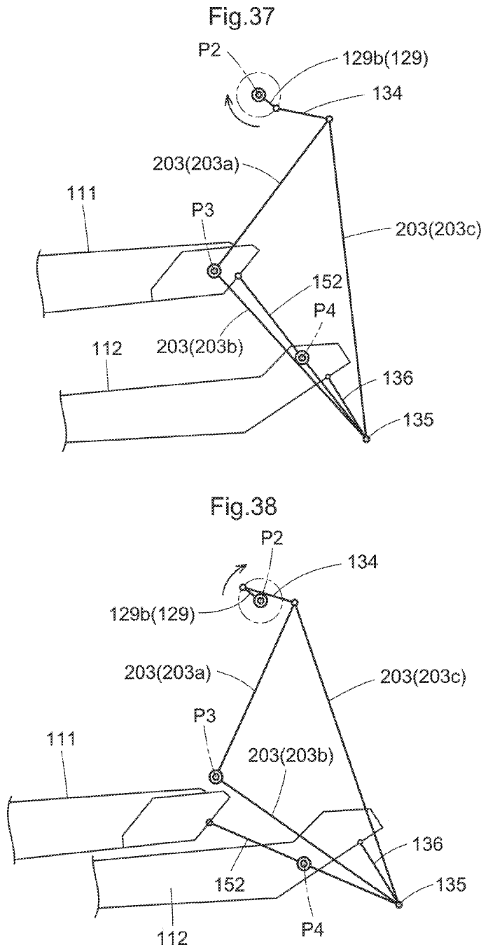

As shown in FIG. 37, when the second sorting unit 112 is driven forward, the drive arm 152 swings clockwise in FIG. 37, and the first sorting unit 111 is driven rearward. As shown in FIG. 38, when the second sorting unit 112 is driven rearward, the drive arm 152 swings counterclockwise in FIG. 38, and the first sorting unit 111 is driven forward. In this way, the first sorting unit 111 and the second sorting unit 112 are driven to reciprocate in opposite directions along the front-rear direction.

As shown in FIG. 20, the front-rear length of the second sorting unit 112 (second sieve case 125) is shorter than the front-rear length of the first sorting unit 111 (first sieve case 123). The plate thickness of the second sieve case 125 is set slightly thicker than the plate thickness of the first sieve case 123, and the weight of the first sorting unit 111 and the weight of the second sorting unit 112 are set substantially the same.

The above state is a state in which the first sorting unit 111 and the second sorting unit 112 are separately driven to reciprocate by the drive member 151, which is the first drive mechanism, and the drive arm 152, which is the second drive mechanism.

Out of the first sorting unit 111 and the second sorting unit 112, the second sorting unit 112 is reciprocally driven by the drive member 151, which is the first drive mechanism.

Out of the first sorting unit 111 and the second sorting unit 112, the reciprocating driving of the second sorting unit 112 is transmitted, via the drive arm 152 serving as the second drive mechanism, to the first sorting unit 111, which is the other one out of the first sorting unit 111 and the second sorting unit 112, and thus the first sorting unit 111, which is the other one out of the first sorting unit 111 and the second sorting unit 112, is driven to reciprocate.

Positional Relationship of Portions in First Sorting Unit and Second Sorting Unit

The following describes the positional relationship between portions when the first sorting unit 111 and the second sorting unit 112 are driven to reciprocate in the front-rear direction as described in the previous section “Reciprocating driving of first sorting unit and second sorting unit”.

In the states shown in FIGS. 20, 21, and 22, the first sorting unit 111 is located at the rear end in reciprocating movement, and the second sorting unit 112 is located at the front end in the reciprocating driving.

With the second sorting unit 112 located at the front end in the reciprocating driving, the rear end portion 122a of the second grain pan 122 (the front end portion 126a of the grain sieve 126) is located behind a vertical line L1 that passes through the peak portion 154a of the front partition unit 154 in a side view.

With the second sorting unit 112 located at the front end in the reciprocating driving, the rear end portion 121b of the first grain pan 121 and the front end portion 131a of the first chaff sieve 131 are located above a front-rear center portion 122b of the second grain pan 122.

Accordingly, in the state where the first sorting unit 111 is located at the rear end in the reciprocating movement and the second sorting unit 112 is located at the front end in the reciprocating driving, and also in the state where the first sorting unit 111 is located at the front end in the reciprocating movement and the second sorting unit 112 is located at the rear end in the reciprocating driving, the first grain pan 121, the first chaff sieve 131, and the second grain pan 122 are arranged such that the rear portion of the first grain pan 121 and the front portion of the first chaff sieve 131 are overlapped with the second grain pan 122 in a plan view.

The rear end portion 126b of the grain sieve 126 is located between a vertical line L2 that passes through the peak portion 155a of the rear partition unit 155 and a vertical line L3 that passes through the screw axis P6 of the tailings collecting unit 142 in a side view.

In this case, when the second sorting unit 112 is located at the front end in the reciprocating driving, the rear end portion 126b of the grain sieve 126 is located slightly rearward of the vertical line L2 in a side view. When the second sorting unit 112 is located at the rear end in the reciprocating driving, the rear end portion 126b of the grain sieve 126 is located slightly forward of the vertical line L3 in a side view.

When the second sorting unit 112 is located at the front end in the reciprocating driving, the front end portion 132a of the second chaff sieve 132 is located at the position of a vertical line L4 that passes through the rear end portion of the transport screw 153 of the tailings collecting unit 142 in a side view, and the second chaff sieve 132 extends rearward from the vertical line L4 that passes through the rear end portion of the transport screw 153 of the tailings collecting unit 142 in a side view.

The straw rack 124 extends rearward until the rear end portion 124a of the straw rack 124 is located above the rear portion of the second chaff sieve 132.

A rearward and upward inclination angle B1 of the first chaff sieve 131 relative to the horizontal plane is set larger than a rearward and upward inclination angle B2 of the first grain pan 121 relative to the horizontal plane.

Until the front end portion 121a of the first grain pan 121 is located at the same position in the front-rear direction as the front end portion 165f of the grain fan case 165 (front case portion 165a), the first grain pan 121 extends forward through the space between the receiving net 114 and the grain fan case 165.

### Variations of Second Embodiment

(1) In the drive member 151, the portions 203a and 203b of the third member 203 may be omitted, and the portion 203c of the third member 203 may remain.

According to this configuration, the third member 203 (portion 203c) is connected to and extends between the connection portion where the crank shaft 129 and the first member 201 are connected and the connection portion where the second sorting unit 112 (interconnecting shaft 135) and the second member 202 are connected, and the third member 203 (portion 203c) is not coupled to the boss portion 204.

(2) In the drive member 151, the first member 201 may be rod-shaped, such as being round bar-shaped, instead of being plate-shaped. The second member 202 may be rod-shaped, such as being round bar-shaped, instead of being plate-shaped. The third member 203 may be rod-shaped, such as being round bar-shaped, instead of being plate-shaped.

(3) In the drive member 151, in the case where the third member 203 is arranged between the first member 201 and the second member 202, the second member 202 may be arranged closer to the lateral center of the first and second sorting units 111 and 112 (closer to the side wall 133) than the third member 203 is, and the first member 201 may be arranged outward of the third member 203 (on the side opposite to the side wall 133).

(4) In the drive member 151, instead of the third member 203 being arranged between the first member 201 and the second member 202, the third member 203 may be arranged closer to the lateral center of the first and second sorting units 111 and 112 (closer to the side wall 133) than the first member 201 and the second member 202 are, or may be arranged outward of the first member 201 and the second member 202 (on the side opposite to the side wall 133).

(5) The coupling between the drive member 151 and the interconnecting shaft 135 may be omitted, and the drive member 151 may be connected to the interconnecting shaft 137.

According to this configuration, the drive member 151 is connected to the first sorting unit 111 via the interconnecting shaft 137, and the drive member 151 is driven by the first sorting unit 111 to reciprocate along the front-rear direction. Due to the first sorting unit 111 reciprocating in the front-rear direction, the drive arm 152 is driven to reciprocally swing around the arm axis P4, and the second sorting unit 112 is driven to reciprocate along the front-rear direction.

(6) Instead of both the first sorting unit 111 and the second sorting unit 112 being provided, one sorting unit may be provided.

(7) The present invention is applicable not only to a threshing device of a normal-type combine harvester but also to a threshing device mounted in an autodetachable combine harvester.

### DESCRIPTION OF REFERENCE SIGNS

### First Embodiment

4 Threshing device
5 Grain tank
5A Bottom screw
6 Engine
6a Output shaft
20 Body frame
23 Threshing chamber
27 Support frame
30 Top plate
30F Front wall portion
31 Threshing cylinder
32 Receiving net
33 Raking unit
34 Threshing processing unit
55 Front support column
56 Rear support column
57 First lateral coupling body
58 Second lateral coupling body
58a Side surface
59 Vertical coupling body
63 Opening
67 Bracket
68 Top plate placement portion
69 Coupling body support portion
78 Threshing inlet plate (guide member)
83 Movable top plate portion
84 Flange portion
85 Sealing member

### Second Embodiment

105 Threshing unit
111 First sorting unit (sorting unit)
112 Second sorting unit (sorting unit)
129 Crank shaft (drive unit)
151 Drive member
201 First member
202 Second member
203 Third member
203a Portion of third member
203b Portion of third member
203c Portion of third member
204 Boss portion
211 First connecting portion
212 Second connecting portion
P3 Axis

1. A combine comprising:
a threshing device configured to thresh reaped culm in a threshing chamber;
a grain tank disposed above the threshing device and configured to store grain threshed by the threshing device;
a threshing cylinder disposed in the threshing chamber and configured to rotate about a front-rear axis;
an arc-shaped receiving net extending along an outer circumferential portion of the threshing cylinder;
a raking unit disposed at a front portion of the threshing cylinder and configured to rake in reaped culm; and
a threshing processing unit disposed rearward of the raking unit in the threshing cylinder and configured to thresh the reaped culm,
wherein the threshing device comprises a top plate covering an upper portion of the threshing chamber and comprising a portion that extends from a position corresponding to an upper portion of the raking unit to a position corresponding to an upper portion of the threshing processing unit and that is removable from a body portion of the threshing device rearward relative to a body of the combine.

2. The combine according to claim 1,
wherein the top plate comprises:
at a front end portion thereof, a front wall portion fixed to the body portion of the threshing device; and
a flange portion extending rearward relative to the body of the combine from the front wall portion,
wherein the top plate comprises a movable top plate portion configured to be inserted and pulled out, and
wherein the movable top plate portion comprises a front end portion closely fitted in an inner surface potion of the flange portion.

3. The combine according to claim 1,
wherein the top plate comprises:
at a front end portion thereof, a front wall portion fixed to the body portion of the threshing device; and
a flange portion extending rearward relative to the body of the combine from the front wall portion,
wherein the top plate comprises a movable top plate portion configured to be inserted and pulled out, and
wherein the movable top plate portion comprises a front end portion closely fitted around an outer surface potion of the flange portion.

4. The combine according to claim 2,
wherein the top plate comprises a sealing member between the flange portion and the front end portion of the movable top plate portion.

5. The combine according to claim 1, further comprising:
a guide member disposed below the raking unit and configured to guide introduced reaped culm, and
wherein the guide member is removable forward relative to the body of the combine.

6. A combine comprising:
a threshing device supported by a body frame and configured to thresh reaped grain;
a grain tank disposed above the threshing device and configured to store grain obtained by the threshing; and
a support frame that supports the grain tank to the body frame,
wherein the threshing device has at a laterally outward side portion thereof an opening extending from a front portion of the threshing device to a rear portion of the threshing device and configured to be exposed and closed with a lid,
wherein the support frame comprises:
a front support column forward of a front end of the opening;
a rear support column rearward of a rear end of the opening;
a first lateral coupling body that couples an upper end portion of the front support column to an upper end portion of the rear support column;
a second lateral coupling body that couples the front support column to the rear support column between the first lateral coupling body and an upper end of the opening; and
a vertical coupling body that couples the first lateral coupling body to the second lateral coupling body, and
wherein the support frame does not overlap with the opening in a side view of a body of the combine.

7. The combine according to claim 6,
wherein the grain tank protrudes laterally outward of the threshing device on a side, and
wherein the first lateral coupling body is laterally outward of the second lateral coupling body on the side, and supports from below a protruding portion of the grain tank that protrudes laterally outward on the side.

8. The combine according to claim 6,
wherein the threshing device comprises:
a threshing cylinder; and
an arc-shaped receiving net extending along an outer peripheral portion of the threshing cylinder, and
wherein:
the second lateral coupling body is laterally outward of the threshing cylinder on a side and faces the threshing cylinder,
the second lateral coupling body has a laterally inward side surface that faces the threshing cylinder, the laterally inward side surface is a flat surface smooth in an up-down direction,
the second lateral coupling body comprises an upper portion wider than a lower portion of the second lateral coupling body,
the receiving net is continuous in a circumferential direction with the laterally inward side surface of the second lateral coupling body, and
the second lateral coupling body comprises a narrow lower portion provided with a coupling bracket coupled to a laterally outward side thereof.

9. The combine according to claim 1, wherein:
the threshing device comprises a top plate covering an upper portion of the threshing chamber,
the second lateral coupling body protrudes laterally outward of an outer end portion of the top plate on one lateral side, and
the second lateral coupling body comprises at an upper portion thereof:
a top plate placement section on which the top plate is placeable and supportable; and
a coupling body support section that supports the vertical coupling body at a position laterally outward of the top plate placement section.

10. The combine according to claim 6,
wherein the grain tank comprises a bottom portion provided with a bottom screw that extends laterally and that is configured to transport grain from the grain tank laterally outward to a side, and
wherein the vertical coupling body is below the bottom screw in a side view.

11. The combine according to claim 6, further comprising:
an engine above the threshing device and rearward of the grain tank, and
wherein the vertical coupling body is below an output shaft of the engine in a side view.

12. A threshing device comprising:
a threshing unit configured to thresh a harvested crop;
a sorting unit disposed below the threshing unit, supported in such a manner as to be reciprocally drivable in a front-rear direction, and configured to sort a processed material from the threshing unit;
a drive unit configured to output motive power for reciprocating; and
a drive member connected to the sorting unit and drivable on the motive power from the drive unit to reciprocally swing around an axis extending along a left-right direction and drive the sorting unit to reciprocate,
wherein the drive member comprises:
a first member supported in such a manner as to be swingable around the axis and connected to the drive unit;
a second member supported in such a manner as to be swingable around the axis and connected to the sorting unit; and
a third member that is connected to a first connection portion at which the drive unit and the first member are connected to each other and a second connection portion at which the sorting unit and the second member are connected to each other and that extends between the first connection portion and the second connection portion.

13. The threshing device according to claim 12,
wherein the third member is in a shape of a plate with a dimension in a swing direction that is larger than a dimension thereof in a direction orthogonal to the swing direction.

14. The threshing device according to claim 12,
wherein the first member and the second member are each in a shape of a plate with a dimension in a swing direction that is larger than a dimension thereof in a direction orthogonal to the swing direction.

15. The threshing device according to claim 12,
wherein the third member is triangular in a side view, and comprises:
a portion supported in such a manner as to be swingable around the axis and extending along the first member;
a portion supported in such a manner as to be swingable around the axis and extending along the second member; and
a portion extending between the first connection portion and the second connection portion.

16. The threshing device according to claim 12,
wherein the first member and the second member are separated by a gap in a direction along the axis, and
wherein the third member is between the first member and the second member in a front view.

17. The threshing device according to claim 16,
wherein the first member and the second member are coupled to a single boss portion supported in such a manner as to be rotatable around the axis, so that the first member and the second member are each supported in such a manner as to be swingable around the axis.

18. The threshing device according to claim 17,
wherein the third member is triangular in a side view, and comprises:
a portion extending along the first member;
a portion extending along the second member; and
a portion extending between the first connection portion and the second connection portion, and
wherein the portion extending along the first member and the portion extending along the second member are coupled to the boss portion.

19. The threshing device according to claim 16, further comprising:
a first connecting portion disposed between the first member and the third member in a front view and coupled to the first member and the third member; and
a second connecting portion disposed between the second member and the third member in a front view and coupled to the second member and the third member,
wherein the drive unit and the first connecting portion are connected to each other, and
wherein the sorting unit and the second connecting portion are connected to each other.
